(19) United States
(12) Patent Application Publication
(10) Pub. No.: US 2004/0142268 A1
(43) Pub. Date: Jul. 22, 2004

(54) Toner and image forming method

(75) Inventors: Takao Yamanouchi, Tokyo (JP); Masafumi Uchida, Tokyo (JP); Masahiro Anno, Osaka (JP); Yoshitaka Sekiguchi, Nishinomiya-shi (JP); Chikara Tsutsui, Nishinomiya-shi (JP)

Correspondence Address: MUSERLIAN AND LUCAS AND MERCANTI, LLP, 475 PARK AVENUE SOUTH, NEW YORK, NY, 10016, US

(73) Assignees: Konica Minolta Holdings, Inc., Tokyo (JP); Minolta Co., Ltd., Osaka (JP)

(21) Appl. No.: 10/665,591

(22) Filed: Sep. 18, 2003

(30) Foreign Application Priority Data
Sep. 19, 2002 (JP) PAT 2002-273208

(51) Int. Cl. G03G 9/08

(52) U.S. Cl. 430/111.4; 430/120; 430/45; 430/137.14

(57) ABSTRACT

A toner includes a resin and a colorant, wherein the toner is obtained by carrying out a step of salting-out/fusing resin particles and colorant particles in a water-base medium, the toner having a compressive strength of 14 to 20, and a standard deviation of the compressive strength of smaller than 1.

### BACKGROUND OF THE INVENTION

1. Field of the Invention

The present invention relates to a toner for use in an image forming method in which an image is developed by a non-magnetic single component development system, and the image forming method.

2. Description of the Related Art

Technical information related to the present invention can be obtained e.g. from the following patent documents:

Patent Document 1:

Japanese Laid-Open Patent Publication No. 8-240923

Patent Document 2:

Japanese Patent Publication No. 2964821.

Recently, to form a color image e.g. by electronic photography, for example, a non-magnetic single component development system in which a latent image formed on an electrostatic latent image carrier is developed by a toner carried and transferred by a toner carrier to which a toner layer limiting member for limiting the amount of the toner on the surface of the toner carrier is pressed, is employed.

In the non-magnetic single component development system, a polymerization toner having uniform electrostatic chargeability and exhibiting a sharp electrostatic charge distribution due to its uniformity in shape and particle diameter has been suitably employed as a non-magnetic single component developer.

One known technique of obtaining a polymerization toner is a suspension polymerization method. The suspension polymerization method is capable of forming a toner spherical in particle shape and high in flowability. However, it is impossible to apply an appropriate friction to the toner, which makes it difficult to stably supply the toner to the toner carrier e.g. from a supply roller. Further, it is difficult to uniformly charge a toner thin layer on the toner carrier. For example, under a low-temperature and low-humidity environment, the amount of toner supplied to the toner carrier is increased, which makes it impossible to limit the amount of toner supplied to the toner carrier. Thus, it is difficult to stably limit the amount of toner under a low-temperature and low-humidity environment or under a high-temperature and high-humidity environment, or due to the difference between a condition of the toner at the start of use thereof and a condition of the same after a long-term use under a low-temperature and low-humidity environment or a high-pressure and high-humidity environment. Therefore, after development, it is impossible to collect the toner from the toner carrier or replenish the toner properly as required. This makes the amount of electric charge on the toner carrier non-uniform, and therefore there is a fear of generation of a so-called development ghost. To overcome this problem, as the non-magnetic single component developer, a toner produced by a so-called association method is widely used which includes a step of salting-out/fusing resin particles and colorant particles in a water-base medium, since the shape of toner particles to be formed can be controlled to various shapes ranging from a spherical shape to an indefinite shape, and moreover the characteristics thereof can be controlled by sharpening the particle diameter distribution.

However, in the non-magnetic single component development system, when the amount of toner on the toner carrier is limited by the toner layer limiting member, the toner is charged by friction, whereby the toner is carried by the toner carrier, and therefore, to electrically charge the toner in a necessary amount by frictional charge, high pressure is applied to the toner, which causes part of the toner to be broken or chipped. Toner fines produced by such breaking and chipping are melted on surfaces of the toner carrier and the toner layer limiting member to be attached as stains to component elements of the image forming apparatus, which, after all, makes it impossible to obtain a high-quality image with stability.

### SUMMARY OF THE INVENTION

The present invention has been made in view of the above circumstances, and an object thereof is to provide a toner with which a high-quality image can be stably obtained by the non-magnetic single component development system.

Another object of the present invention is to provide an image forming method which makes it possible to stably obtain a high-quality image by the non-magnetic single component development system.

In accordance with the first aspect of the invention, a toner comprises a resin and a colorant,

wherein the toner is obtained by carrying out a step of salting-out/fusing resin particles and colorant particles in a water-base medium, the toner having a compressive strength of 14 to 20, and a standard deviation of the compressive strength of smaller than 1.

Preferably, the toner has a peak or a shoulder in a molecular weight distribution range from 100,000 to 1,000,000, and from 1,000 to 50,000.

Preferably, the toner further comprises an external additive having an average primary particle diameter of 30 to 500 nm.

Preferably, the resin particles of the toner have a softening point of 90 to 140° C.

In accordance with the second aspect of the invention, a toner for a non-magnetic single component full-color development, is used in an image forming method in which a yellow toner (Y), a magenta toner (M), a cyan toner (C), and a black toner (K) are used, the image forming method comprising the steps of: limiting an amount of each toner on a surface of a toner carrier by allowing a toner layer limiting member to be pressed to the surface of the toner carrier; and developing an electrostatic latent image formed on a surface of an electrostatic latent image carrier using the each toner carried and transferred by the toner carrier, based on a non-magnetic single component development system,

wherein the toner is obtained by carrying out a step of salting-out/fusing resin particles and colorant particles in a water-base medium, and has a number average particle diameter of 3 to 9 μm, an average circularity of 0.955 to 0.990, a standard deviation of the average circularity of not larger than 0.040, a compressive strength of 14 to 20, and a standard deviation of the compressive strength of smaller than 1.

Preferably, the toner has a peak or a shoulder in a molecular weight distribution range from 100,000 to 1,000,000, and from 1,000 to 50,000.

Preferably, the toner further comprises an external additive having an average primary particle diameter of 30 to 500 nm.

Preferably, the resin particles of the toner have a softening point of 90 to 140° C.

In accordance with the third aspect of the invention, an image forming method comprises the steps of:

limiting an amount of toner on a surface of a toner carrier by allowing a toner layer limiting member to be pressed to the surface of the toner carrier; and

developing an electrostatic latent image formed on an electrostatic latent image carrier using the toner carried and transferred by the toner carrier, based on a non-magnetic single component development system,

wherein the toner comprises a resin and a colorant, and is obtained by carrying out a step of salting-out/fusing resin particles and colorant particles in a water-base medium, the toner having a compressive strength of 14 to 20, and a standard deviation of the compressive strength of smaller than 1.

Preferably, the toner has a peak or a shoulder in a molecular weight distribution range from 100,000 to 1,000,000, and from 1,000 to 50,000.

Preferably, the toner further comprises an external additive having an average primary particle diameter of 30 to 500 nm.

Preferably, the resin particles of the toner have a softening point of 90 to 140° C.

In accordance with the fourth aspect of the invention, an image forming method comprises the steps of:

limiting an amount of toner on a surface of a toner carrier by allowing a toner layer limiting member to be pressed to the surface of the toner carrier; and

developing an electrostatic latent image formed on an electrostatic latent image carrier using the toner carried and transferred by the toner carrier, based on a non-magnetic single component development system,

wherein the toner is obtained by carrying out a step of salting-out/fusing resin particles and colorant particles in a water-base medium, and has a number average particle diameter of 3 to 9 μm, an average circularity of 0.955 to 0.990, a standard deviation of the average circularity of not larger than 0.040, a compressive strength of 14 to 20, and a standard deviation of the compressive strength of smaller than 1, and

wherein the toner carrier has an arithmetic average roughness Ra of 0.8 to 2.5 μm and a ten-point average roughness Rz of 5.0 to 15.0.

Preferably, the toner has a peak or a shoulder in a molecular weight distribution range from 100,000 to 1,000,000, and from 1,000 to 50,000.

Preferably, the toner further comprises an external additive having an average primary particle diameter of 30 to 500 nm.

Preferably, the resin particles of the toner have a softening point of 90 to 140° C.

The toner according to the present invention is a toner obtained by carrying out the step of salting-out/fusing resin particles and colorant particles in a water-base medium (hereinafter referred to as “associated-type toner”). The toner has a specific compressive strength and a standard deviation thereof, and therefore it is possible to obtain an excellent image formability and high toughness. This makes it possible to give a necessary amount of electric charge to the toner without detrimental effects of the action of frictional charge by the toner carrier and the toner layer limiting member, and therefore, obtain a high-quality image over a long time period.

Therefore, according to the toner of the present invention, it is possible to stably obtain a high-quality image by the non-magnetic single component development system.

### BRIEF DESCRIPTION OF THE DRAWINGS

FIG. 1 is an explanatory schematic view showing an example of the arrangement of an image forming apparatus used in the present invention;

FIG. 2 is an explanatory cross-sectional view of the arrangement of a developing unit of a developing device of the image forming apparatus shown in FIG. 1;

FIG. 3 is an explanatory view illustrating a curve indicative of a contour of cross-section of a portion of a toner carrier; and

FIG. 4 is an explanatory view useful in explaining a ten-point average roughness Rz.

### DETAILED DESCRIPTION OF THE PREFERRED EMBODIMENTS

The invention will now be described in detail with reference to the drawings showing a preferred embodiment thereof.

Toner according to the present invention contains a resin, and a colorant. The toner is obtained by carrying out the step of salting out/fusing resin particles and colorant particles, and has characteristics of a compressive strength of 14 to 20 and a standard deviation of the compressive strength of smaller than 1. Further, the toner may contain an additive, such as an external additive.

The compressive strength is measured by a micro compression testing machine, and a value thereof indicates a toughness (stress resistant property) in a state of pressure being applied to each of toner particles forming the toner. More specifically, a value of compressive strength is obtained by measuring micro-compression strength of arbitrary ten toner particles having a number average particle diameter within a range of +20%, particle by particle, under a measurement environment controlled to a temperature of 21 to 23° C., and a relative humidity of 45 to 65% RH, and measurement conditions of a maximum test load of 9.8 mN and a load speed of 0.89 mN/sec, and calculating an arithmetic average value of a total of 6 measurement values obtained by excluding two largest measurement values and two smallest measurement values from the results of the measurement.

When the compressive strength is smaller than 14, the toner does not have a sufficient crushing strength, so that high pressure applied to the toner when frictional charge is caused to occur using the toner carrier and the toner layer limiting member crushes (breaks, or chips) toner particles, causing stains to be attached to component elements of the image forming apparatus, which makes it impossible to obtain a high-quality image with stability by the non-magnetic single component development system. On the other hand, when the compressive strength exceeds 20, deformability of toner particles is low, so that the high pressure applied to the toner when frictional charge is caused to occur using the toner carrier and the toner layer limiting member partially breaks or chips toner particles, producing fines of toner, causing stains caused by the fines to be attached to component elements of the image forming apparatus, which makes it impossible to obtain a high-quality image with stability by the non-magnetic single component development system.

Further, it is preferred that the compressive strength is 14 to 18.

When the standard deviation of the compressive strength is equal to or larger than 1, variation of the compressive strength between toner particles is large, which causes crushing (breaking or chipping) of toner particles having a weak compressive strength at a location where pressure contact force is applied, such as a toner layer limiting member, and fine toner particles (toner fines) produced thereby are stuck to the toner carrier and the toner layer limiting member. Then, fusion bonding of fine toner particles further proceeds at each of portions where toner fines are stuck, as a core, so that the portion grows, eventually causing formation of undesired white lines on an image or following failure at filled-in areas of an image. As described above, even when the compressive strength (average value) of the toner is within a favorable range, if the toner partially contains toner particles having a small compressive strength (easily breakable), the toner particles can be crushed to cause deterioration of an image to an unallowable level.

Further, it is preferred that the standard deviation of the compressive strength is equal to or lower than 0.75.

It is preferred that the toner according to the invention has a number average particle diameter of 3 to 9 mm.

The number average particle diameter can be measured e.g. by using a “Coulter Counter TA-II”, a “Coulter Multisizer” (both of which are available from Coulter Electronics Inc.), or a laser diffraction-type particle diameter measuring apparatus “SLAD1100” (available from Shimadzu Corporation).

In the present invention, the volume average particle diameter is measured using the “Coulter Counter TA-II” connected to an interface (available from Nikkaki-bios Co., Ltd.) and calculated by a personal computer which outputs a particle diameter distribution.

It is preferred that the toner according to the present invention has an average circularity of 0.955 to 0.990, particularly 0.960 to 0.985, the average circularity being an average value of values of a shape factor represented by the following Equation (1):

Shape Factor=L1/L2 (1)

where L1 is a length of a periphery of a circle, which is determined from a diameter of corresponding circle, and L2 is a length of periphery of toner particle projection image.

Due to the average circularity being equal to or larger than 0.955 and equal to or lower than 0.990, the shape of toner particles is made irregular to some extent, which enables the toner to maintain a transferability and at the same time a frictional chargeability, in the non-magnetic single component development system, whereby an appropriate electrostatic chargeability can be imparted thereto.

The method of measuring a shape factor is not particularly limited, but the average circularity can be calculated by taking a picture of toner particles magnified to 500 times by an electron microscope, then measuring the shape factor of each of 500 toner particles using an image analyzer, and calculating an arithmetic average value of measured vales of the shape factor.

To measure the shape factor in an easy and convenient fashion, it is possible to employ, by way of example, a method utilizing a flow-type particle image analyzer “FPIA-2000” (available from To a Medical Electronics Co., Ltd.).

Further, it is preferred that the shape factor (circularity) distribution is sharp, and it is preferred that the standard deviation of circularity is equal to or lower than 0.040.

When the standard deviation of circularity exceeds 0.40, the difference in chargeability between toner particles becomes significant, so that the distribution of amounts of electrostatic charge caused by the action of the frictional charge is expanded, whereby the problem of fogging can be caused by generation of so-called weakly charged toner.

In a molecular weight distribution measured by GPC (gel permeation chromatography), the toner according to the present invention has peaks or shoulders preferably in a range of 100,000 to 1,000,000 and a range of 1,000 to 50,000, more preferably in the range of 100,000 to 1,000,000, a range of 25,000 to 150,000, and the range of 1,000 to 50,000.

The molecular weight of a resin is measured by GPC by the following method: One ml of tetrahydrofuran (THF) is added to 0.5 to 5.0 mg (specifically 1 mg) of a sample, and the sample is fully dissolved by stirring the mixture at room temperature using a magnetic stirrer or the like. Then, the mixture is filtered through a membrane filter having a pore size of 0.45 to 0.50 μm, and then injected into GPC.

The molecular weight of the sample is measured by GPC under conditions that columns are stabilized at 40° C., THF is caused to flow at a flow rate of 1 ml per minute, and an approximately 100 μl of the sample having a concentration of 1 mg/ml is injected for measurement. It is preferable to use a combination of commercially available polystyrene gel columns. For example, there may be used a combination of Shodex GPC KF-801, 802, 803, 804, 805, 806, 807, available from Showa Denko Company, and a combination of TSKgel G1000H, G2000H, G3000H, G4000H, G5000H, G6000H, G7000H, and TSK guard column, available from Tosoh Corporation. Further, as a detector, a refractive index detector (IR detector), or a UV detector is conveniently used. In measuring the molecular weight of the sample, the molecular weight distribution of the sample is calculated using a calibration curve prepared using monodisperse polystyrene standard particles. It is advisable to use about ten kinds of polystyrene for preparing the calibration curve.

The toner according to the present invention is made by adding an electric charge control agent to resin particles as required, then adding colorant particles, an organic solvent, and a flocculant, such as salts, to the mixture to thereby salt-out/fuse the resin particles and the colorant agents in a water-base medium. This method is not particularly limited, but disclosed e.g. in Japanese Laid-Open Patent Publications (Kokai) No. 5-265252, No. 6-329947, and No. 9-15904. More specifically, the toner according to the present invention can be formed by a method of associating a plurality of disperse particles of component materials, such as resin particles and a colorant, or a plurality of fine particles comprised of a resin and a colorant, particularly, by dispersing these particles in water using an emulsifier, then adding a flocculant having a concentration higher than a critical flocculation concentration to the dispersion, for salting out, and at the same time, heating the thus formed polymer at a temperature higher than a glass transition temperature of the polymer itself to fuse particles to each other to thereby grow the particles such that the particle diameter thereof is gradually increased, stopping increasing the particle diameter by adding a large amount of water thereto when a desired particle diameter is reached, further controlling the shape of particles by heating and stirring the mixture such that the particle surface becomes smooth, and heating the particles still hydrous in a flowable state to dry the same. It should be noted that when the flocculant is added, a solvent which is infinitely soluble to water may be added.

As the resin particles, particles of a resin containing at least two components, i.e. a high molecular weight component having peaks or shoulders in a range of 100,000 to 1,000,000, and a low molecular weight component having peaks or shoulders in a range of 1,000 to less than 50,000, are preferable, and particles of a resin additionally having a medium molecular weight resin having peaks or shoulders in a range of 15,000 to 100,000 are more preferable.

Preferably, the resin particles have a glass transition temperature of 45 to 70° C., more preferably 50 to 65° C., and further, the resin particles have a softening point of 90 to 140° C.

The resin particles can be prepared by subjecting a polymerizable monomer to a polymerization process in a water-base medium, e.g. by a granulation polymerization method, such as an emulsification polymerization method. As the polymerizable monomer used for obtaining the resin particles, a radical polymerizable monomer is an essential component, and a cross-linkable monomer (crosslinker) may be used as required. Further, it is preferable that polymerizable monomer contains at least one kind of radical polymerizable monomer having an acidic group or a basic polymerizable monomer having a basic group.

(1) Radical Polymerizable Monomers

The radial polymerizable monomers are not particularly limited, but conventionally known radical polymerizable monomers can be used. Further, it is possible to use one kind of monomer or a combination of two or more kinds of monomers so as to satisfy the required characteristics.

More specifically, it is possible to use aromatic vinyl monomers, (meth)acrylic ester monomers, vinyl ester monomers, vinyl ether monomers, monoolefin monomers, diolefin monomers, and halogenated olefin monomers.

Examples of the aromatic vinyl monomers include styrene monomers and derivatives thereof, such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene.

Examples of the (meth)acrylate monomers are methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate.

Examples of the vinyl ester monomers include vinyl acetate, vinyl propionate, and vinyl benzoate.

Examples of the vinyl ether monomers include vinylmethylether, vinylethylether, vinylisobutylether, and vinylphenylether.

Examples of the monoolefin monomers include ethylene, propylene, isobutylene, 1-butene, 1-pentene, and 4-methyl-1-pentene.

Examples of the diolefin monomers include butadiene, isoprene, and chloroprene.

(2) Crosslinkable Monomers

To improve characteristics of a toner as a final produced, a radical polymerizable crosslinking agent may be added as a crosslinkable monomer. Examples of the radical polymerizable crosslinking agent include monomers having two or more unsaturated bonds, such as divinyl benzene, divinyl naphthalene, divinyl ether, diethyleneglycol methacrylate, ethyleneglycol dimethacrylate, polyethyleneglycol dimethacrylate, and diallyl phthalate.

(3) Radical Polymerizable Monomers Having an Acidic Group

Examples of the radical polymerizable monomers having an acidic group include α, β-ethylenic unsaturated monomers having a carboxyl group (—COOH), and α, β-ethylenic unsaturated monomers having a sulfonic acid group (—SO₃H).

Examples of the α, β-ethylenic unsaturated monomers having a carboxyl group (—COOH) include acrylic acid, methacrylic acid, fumaric acid, maleic acid, itaconic acid, cinnamic acid, monobutylester maleate, monooctylester maleate, and metal salts thereof, such as sodium (Na) and zinc (Zn) slats thereof.

Examples of the α, β-ethylenic unsaturated monomers having a sulfonic acid group include sulfonated styrene and sodium salts thereof, allyl sulfosuccinate, octylallyl sulfosuccinate, and sodium salts thereof.

(4) Radical Polymerizable Monomers Having a Basic Group

Examples of the radical polymerizable monomers having a basic group include (a) (meth)acrylates of aliphatic alcohols having an amine group or a quaternary ammonium group, and having 1 to 12 carbon atoms, preferably 2 to 8 carbon atoms, particularly preferably 2 carbon atoms, (b) (meth)acrylic acid amides, or mono- or di-alkyl-substituted (meth)acrylic acid amides substituted on an arbitrary N atom with an alkyl group having 1 to 18 carbon atoms, (c) vinyl compounds substituted with heterocyclic rings having an N atom as a ring member, (d) N,N-diallyl-alkylamines, or quaternary ammonium salts thereof. Among these, (a) (meth)acrylates of aliphatic alcohols having an amine group or a quaternary ammonium group are preferable as the monomers having a basic group.

Examples of (a) (meth)acrylates of aliphatic alcohols having an amine group or a quaternary ammonium group include dimethylaminoethyl acrylate, dimethylaminoethyl methacrylate, diethylaminoethyl acrylate, diethylaminoethyl methacrylate, quaternary ammonium salt of the above four compounds, 3-dimethylaminophenyl acrylate, and 2-hydroxy-3-methacryloxypropyltrimethylammonium salt.

Examples of (b) (meth)acrylic acid amides, or mono- or di-alkyl-substituted (meth)acrylic acid amides substituted on an arbitrary N atom with an alkyl group having 1 to 18 carbon atoms include acrylamide, N-butyl acrylamide, N,N-dibutyl acrylamide, piperidyl acrylamide, methacrylamide, N-butyl methacrylamide, N,N-dimethyl acrylamide, and N-octadecyl acrylamide.

Examples of (c) vinyl compounds substituted with a heterocyclic ring having an N atom as a ring member include vinylpyridine, vinylpyrrolidone, vinyl-N-methylpyridinium chloride, and vinyl-N-ethylpyridinium chloride.

Examples of (d) N,N-diallyl-alkylamines include N, N-diallyl-methylammonium chloride, and N,N-diallyl-ethylammonium chloride.

In order to adjust the molecular weight of resin particles, a known chain transfer agent can be used.

The chain transfer agent is not particularly limited, but mercapto compounds having a mercapto group, such as octyl mercaptan, dodecyl mercaptan, and tert-dodecyl mercaptan, are used. Particularly, mercapto compounds having a short molecular chain are preferably used, since the use thereof makes it possible to obtain a toner which is suppressed in generation of odor during heating and fixing operations, sharp in molecular weight distribution, and excellent in preservability, fixation strength, and an anti-offsetting property.

Examples of preferable chain transfer agents include propyl thioglycolate, octyl thioglycolate, n-octyl mercaptopropionate, and octyl mercaptan.

In the present invention, any suitable radical polymerization initiators can be used as so long as they are water-soluble. For example, persulfates (potassium persulfate, ammonium persulfate, etc.), azo compounds (4, 4′-azobis(4-cyanovaleric acid) and salts thereof, 2,2′-azobis(2-amidinopropane) and salts thereof, etc.), and peroxide compounds can be used as the radical polymerization initiators.

Further, the radical polymerization initiators can be used as redox initiators by using them in combination with reducing agents as required. By using the redox initiators, polymerization activity is increased, whereby it is possible to lower a polymerization temperature, and hence shortening of a polymerization time period can be expected.

Although any temperature may be selected as the polymerization temperature so long as it is equal to or higher than a lowest radical forming temperature, a temperature within a range of 50 to 90° C. is used. However, when a polymerization initiator for starting polymerization at an ordinary temperature, e.g. a combination of hydrogen peroxide-reducing agent (e.g. ascorbic acid) is used, it is also possible to carry out polymerization at room temperature, or a temperature equal to or higher than the room temperature.

To perform polymerization by using the radical polymerizable monomers described above, it is preferable to disperse oil drops in a water-base medium using a surfactant. The surfactants usuable in the present invention are not particularly limited, but the following are examples of suitable ionic surfactants.

Examples of the ionic surfactants include sulfonates (sodium dodecylbenzenesulfonate, sodium aryl alkyl polyethersulfonate, sodium 3,3-disulfondiphenylurea-4,4-diazo-bis-amino-8-naphthol-6-sulfonate, sodium ortho-caroxybenzene-azo-dimethylaniline-2,2,5,5-tetramethyl-triphenylmethane-4,4-diazi-bis-β-naphthol-6-sulfonate, and the like), sulfates (sodium dodecyl sulfate, sodium tetradecyl sulfate, sodium pentadecyl sulfate, sodium octyl sulfate, etc.), fatty acid salts (sodium oleate, sodium laurate, sodium caprate, sodium caprylate, sodium caproate, potassium stearate, calcium oleate, and the like.).

Among these ionic surfactants, compounds expressed by the following general formula (A) and the following general formula (B) are particularly preferably used.

R¹(OR²)ₚOSO₃M¹ (A)

(wherein R¹ represents an alkyl group or arylalkyl group having 6 to 22 carbon atoms, R² represents an alkylene group having 2 to 6 carbon atoms, and M¹ represents a monovalent metal atom. p represents an integer of 1 to 11.)

R³(OR⁴)_{q}OSO₃M² (B)

(wherein R³ represents an alkyl group or arylalkyl group having 6 to 22 carbon atoms, R⁴ represents an alkylene group having 2 to 6 carbon atoms, and M² represents a monovalent metal atom. q represents an integer of 1 to 11.)

In the general formulas (A) and (B), R¹ and R³ represent an alkyl group or arylalkyl group having 6 to 22 carbon atoms, preferably an alkyl group or arylalkyl group having 8 to 20 carbon atoms, more preferably an alkyl group or arylalkyl group having 9 to 16 carbon atoms.

Examples of the groups R¹ and R³ include alkyl groups, such as an n-hexyl group, an n-heptyl group, an n-octyl group, a n-decyl group, an n-undecyl group, an n-hexadecyl group, a cyclopropyl group, a cyclopentyl group, and a cyclohexyl group, and arylalkyl groups, such as a benzyl group, a diphenyl group, a cynnamyl group, a stylyl group, a trityl group, and a fenetyl group.

In the general formulas (A) and (B), R² and R⁴ represent an alkylene group having 2 to 6 carbon atoms, preferably an alkylene group having 2 to 3 carbon atoms.

Examples of the groups R² and R⁴ are alkylene groups, such as an ethylene group, a trimethylene group, a tetramethylene group, a propylene group, and an ethylethylene group.

In the general formulas (A) and (B), p and q represent an integer of 1 to 11, preferably an integer of 2 to 10, more preferably an integer of 2 to 5, particularly preferably an integer of 2 to 3.

In the general formulas (A) and (B), M¹ and M² represent a monovalent metal atom. Examples of the monovalent metal atom are a sodium atom, and a lithium atom. Of the examples, the sodium atom is preferably used.

Examples of the compound expressed by the general formulas (A) and (B) are compounds expressed by the following formulas (a) to (f):

C₁₀H₂₁ (OCH₂CH₂)₂OSO₃Na (a)

C₁₀H₂₁ (OCH₂CH₂)₃OSO₃Na (b)

C₁₀H₂₁ (OCH₂CH₂)₂SO₃Na (c)

C₁₀H₂₁ (OCH₂CH₂)₃SO₃Na (d)

C₈H₁₇ (OCH₂CH(CH₃))₂OSO₃Na (e)

C₁₈H₃₇ (OCH₂CH₂)₂OSO₃Na (f)

The content of a surfactant comprising a compound expressed by the general formula (A) or the general formula (B) in the toner can be calculated e.g. by the following method:

1 g of toner is dissolved in 50 ml of chloroform, and a surfactant is extracted from a chloroform layer using 100 ml of deionized water. The chloroform layer subjected to the extraction was again subjected to the extraction using 100 ml of deionized water, thereby obtaining a total of 200 ml of a liquid extract (aqueous), and the liquid extract is diluted to 500 ml. The diluted liquid is used as a test liquid. According to the method defined in JIS 33636, the diluted liquid is colored using methylene blue, and absorbance was measured. Using a calibration curve prepared in advance, the content of the surfactant in the toner is measured.

The structure of the compound expressed by the general formula (A) and (B) is determined by analysis of liquid extracts obtained by the above method in NMR measurement.

Further, nonionic surfactants as well can be used. Examples of the nonionic surfactants include polyethylene oxide, polypropylene oxide, a combination of polypropylene oxide and polyethylene oxide, esters of polyethylene glycol with higher fatty acids, alkylphenol polyethylene oxide, esters of polypropylene oxide with higher fatty acids, and sorbitan esters.

The toner according to the present invention may be comprised of resin particles (hereinafter referred to as the “release agent-containing resin particles”) which contain, as required, a crystalline material (hereinafter, simply referred to as a “release agent”) having releasing properties and serving as a fixation-improving agent.

The release agent is not particularly limited, but polyolefin wax, such as low molecular weight polypropylene and low molecular weight polyethylene, paraffin wax, Fischer-Trosch wax, ester wax, and the like, can be used as the release agent. Preferably used is an ester compound represented by the following general formula (C):

R⁵—(OCO—R⁶)ₛ (C)

wherein, R⁵ and R⁶ represent hydrocarbon groups which may have substituents, respectively, and s designates an integer defined as 1≦n≦4).

In the general formula (C), R⁵ and R⁶ represent hydrocarbon groups which may have substituents, respectively. The hydrocarbon group R⁵ has 1 to 40 carbon atoms, preferably 1 to 20 carbon atoms, more preferably 2 to 5 carbon atoms. Further, the hydrocarbon group R⁶ has 1 to 40 carbon atoms, preferably 16 to 30 carbon atoms, and more preferably 18 to 26 carbon atoms.

The hydrocarbon group R⁵ and the hydrocarbon group R⁶ may be identical to or different from each other.

Further, In the general formula (C), s designates an integer defined as 1≦n≦4, preferably 2≦n≦4), and more preferably 3≦n≦4, particularly preferably 4.

Examples of the ester compound include those represented by the following formulas (W1) to W(22):

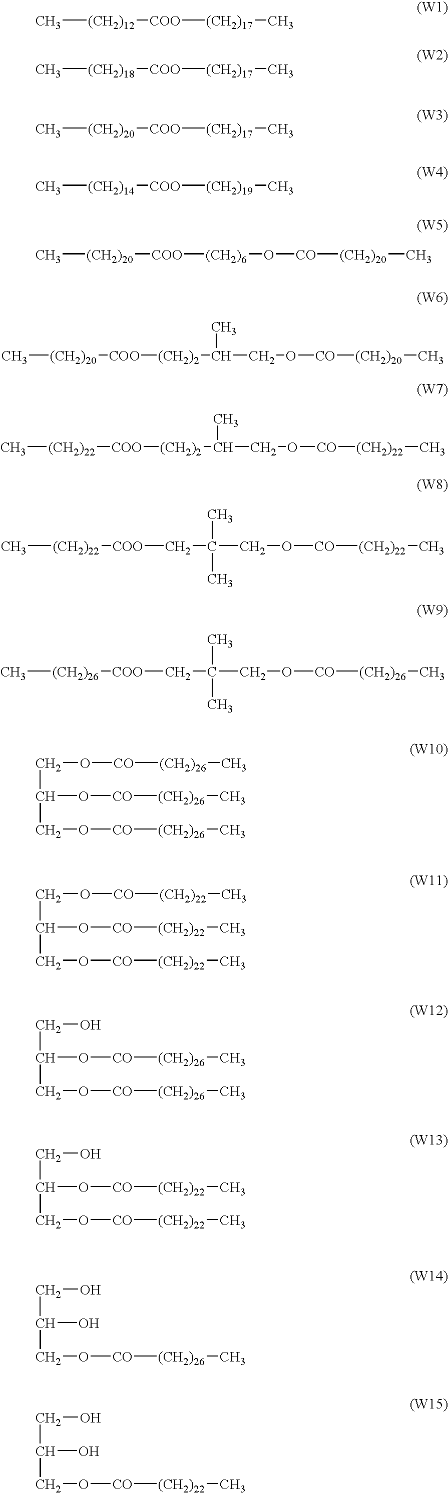

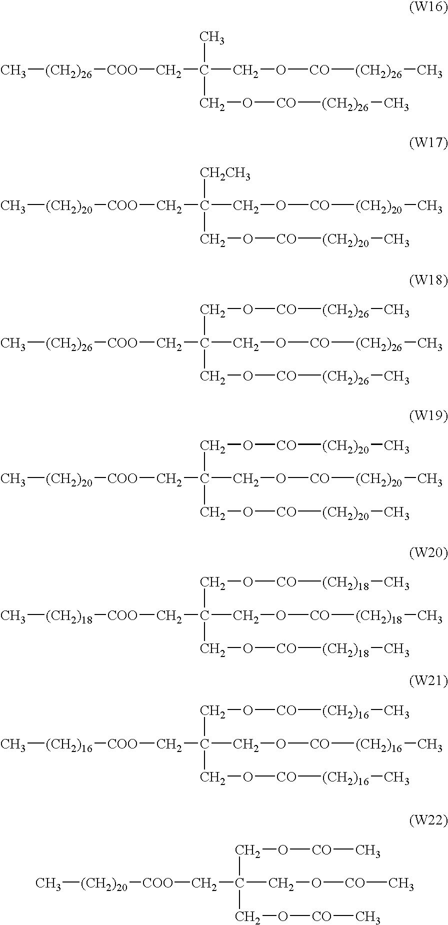

The content of the release agent with respect to whole of the toner is normally 1 to 30 mass %, preferably 2 to 20 mass %, more preferably 3 to 15 mass %.

Although in the present invention, the “release agent-containing resin particles” can be also obtained by the technique of adding release agent particles during execution of salting-out/fusing, it is preferable that the release agent-containing resin particles are obtained by dissolving a release agent at least in a polymerizable monomer, carrying out a step of polymerizing the polymerizable monomer having the release agent contained therein, and salting-out and fusing the resultant composite resin particles and colorant particles. In the resin particles containing a release agent obtained by the above method, the presence of the release agent can be made uniform, and at the same time the difference in presence of the release agent between toners can be eliminated.

A preferable polymerization method for obtaining resin particles having a release agent contained therein includes a radical polymerization method (hereinafter referred to as the “mini-emulsion method” in the present specification), in which in a water-base medium having a surfactant with a concentration equal to or lower than a critical micelle concentration, dissolved therein, a monomer solution formed by dissolving a release agent in a polymerizable monomer is dispersed in the form of oil droplets (10 to 1,000 nm) by using mechanical energy, to prepare a dispersion, and a polymerization initiator is added to the dispersion for carrying out radical polymerization of the polymerizable monomer. According to the mini-emulsion method, differently from the normal emulsion polymerization method, only a small amount of a release agent dissolved in the polymerizable monomer is liberated, so that it is possible to introduce a sufficient amount of the release agent into resin particles formed.

It should be noted that an oil-soluble polymerization initiator may be added to the monomer solution in place of or together with the water-soluble polymerization initiator.

A dispersing apparatus for conducting oil droplet dispersion by using mechanical energy is not particularly limited, but there may be used a mechanical dispersing apparatus “CLEARMIX” (available from M Technique Co., Ltd.) which is a stirring machine equipped with a rotor rotating at a high speed, an ultrasonic wave dispersing machine, a mechanical homogenizer, Manton Gaulin, or a pressure homogenizer.

Further, the disperse particle diameter is in a range of 10 to 1000 nm, preferably 30 to 1000 nm, further preferably 50 to 300 nm.

By making the disperse particles monodisperse, the phase-separating structure of the release agent in the toner particles can be made uniform.

As the colorants, there may be used, for example, magnetic powders, such as magnetite and ferrite, inorganic pigments, organic pigments, and dyes. As the inorganic pigments, the organic pigments, and the dyes, there can be used conventionally known pigments and dyes.

Examples of black inorganic pigments include carbon black, such as furnace black, channel black, acetylene black, thermal black, and lampblack.

These inorganic pigments can be used alone or in combination of two or more, as required.

Further, the amount of an inorganic pigment added is 2 to 20 mass %, preferably 3 to 15 mass %, with respect to the amount of polymer (resin particles).

Examples of the organic pigments for magenta or red include C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53:1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178, and C.I. pigment red 222.

Examples of the organic pigments for orange or yellow include C.I. pigment orange 31, C.I. pigment orange 43, C.I. pigment yellow 12, C.I. pigment yellow 13, C.I. pigment yellow 14, C.I. pigment yellow 15, C.I. pigment yellow 17, C.I. pigment yellow 93, C.I. pigment yellow 94, C.I. pigment yellow 138, C.I. pigment yellow 180, C.I. pigment yellow 185, C.I. pigment yellow 155, and C.I. pigment yellow 156.

Examples of the organic pigments for green or cyan include C.I. pigment blue 15, C.I. pigment blue 15:2, C.I. pigment blue 15:3, C.I. pigment blue 16, C.I. pigment blue 60, and C.I. pigment green 7.

Further, examples of dyes include C.I. solvent red 1, C.I. solvent red 49, C.I. solvent red 52, C.I. solvent red 58, C.I. solvent red 63, C.I. solvent red 111, C.I. solvent red 122, C.I. solvent yellow 19, C.I. solvent yellow 44, C.I. solvent yellow 77, C.I. solvent yellow 79, C.I. solvent yellow 81, C.I. solvent yellow 82, C.I. solvent yellow 93, C.I. solvent yellow 98, C.I. solvent yellow 103, C.I. solvent yellow 104, C.I. solvent yellow 112, C.I. solvent yellow 162, and C.I. solvent blue 25, C.I. solvent blue 36, C.I. solvent blue 60, C.I. solvent blue 70, C.I. solvent blue 93, C.I. solvent blue 95, etc. It is also possible to use mixtures thereof.

The above organic pigments and dye materials can be used alone or in combination of two or more, as required.

Further, the amount of organic pigment added is 2 to 20 mass %, preferably 3 to 15 mass %, with respect to the amount of polymer (resin particles).

The colorants may also be employed while subjected to surface modification. The surface modifying agents may be those conventionally known in the art, and specifically, preferably employed may be silane coupling agents, titanium coupling agents, aluminum coupling agents, and the like.

Examples of the silane coupling agent include alkoxysilanes, such as methyltrimethoxysilane, phenyltrimethoxysilane, methylphenyldimethoxysilane, and diphenyldimethoxysilane, siloxanes, such as hexamethyldisiloxane, γ-chloropropyltrimethoxysilane, vinyltrichlorosilane, vinyltrimethoxysilane, vinyltriethoxysilane, γ-methacryloxypropyl-trimethoxysilane, γ-glycidoxypropyltrimethoxysilane, γ-mercaptopropyltrimethoxysilane, γ-aminopropyl-triethoxysilane, and γ-ureidopropyltriethoxysilane.

Examples of the titanium coupling agent include those marketed with brand “Plainact” TTS, 9S, 38S, 41B, 46B, 55, 138S, 238S etc., available from Ajinomoto Corporation, A-1, B-1, TOT, TST, TAA, TAT, TLA, TOG, TBSTA, A-10, TBT, B-2, B-4, B-7, B-10, TBSTA-400, TTS, TOA-30, TSDMA, TTAB, TTOP etc., marketed by Nihon Soda Co., Ltd.

Examples of the aluminum coupling agent include “Plainact AL-M” available from Ajinomoto Corporation.

The amount of addition of these surface modifiers is preferably in a range of 0.01 to 20% by mass, and more preferably 0.5 to 5% by mass with reference to the colorant.

Surface of the colorant may be modified in such way that the colorant is dispersed in a solvent, the surface modifier is added to the dispersion of the colorant, and then the dispersion is heated to conduct reaction. After termination of the reaction, the colorant having subjected to the surface modification is separated by filtration and dried after repeating rinsing and filtering with the same solvent.

Next, the method for manufacturing the toner according to the present invention comprises, by way of example:

(1) a dissolving step of dissolving a release agent in a polymerizable monomer to thereby prepare a monomer solution,

(2) a dispersing step of dispersing the obtained monomer solution in a water-base medium,

(3) a polymerizing step of subjecting an aqueous dispersion system of the obtained monomer solution to polymerizing to thereby prepare a liquid dispersion (Latex) of resin particles containing the release agent,

(4) a salting-out/fusing step of obtaining toner particles by salting-out/fusing the obtained resin particles and colorant particles in the water-base medium,

(5) a filtering/washing step of separating the obtained toner particles from the water-base medium by filtration, and washing the toner particles to thereby remove a surfactant and the like therefrom, and

(6) a drying step of drying the washed toner particles,

and the method may further comprise (7) an external additive-adding step of adding an external additive to the dried toner particles.

(1) Dissolving Step;

The method of dissolving a release agent in polymerizable monomer is not particularly limited.

It should be noted that an oil-soluble polymerization initiator and other oil-soluble constituents can be added to the monomer solution.

(2) Dispersing Step

Although the method of dispersing the obtained monomer solution in a water-base medium is not particularly limited, it is preferable to employ a method of dispersing the obtained monomer solution by mechanical energy. Particularly, it is preferable to carry out oil droplet dispersion of the monomer solution in a water-base medium formed by dissolving a surfactant to a concentration not higher than a critical micelle concentration, by making use of mechanical energy. This manner of dispersion is essential to the mini-emulsion method.

A dispersing apparatus for conducting oil droplet dispersion by using mechanical energy is not particularly limited, but there may be used a mechanical dispersing apparatus “CLEARMIX”, an ultrasonic wave dispersing machine, a mechanical homogenizer, Manton Gaulin, or a pressure homogenizer. The disperse particle diameter is 10 to 1000 nm, preferably 30 to 3000 nm.

(3) Polymerizing Step

In the polymerizing step, there may be employed, basically, a granulation polymerization method, including the emulsion polymerization method, the suspension polymerization method, and a seed polymerization method, and an example of a preferable polymerization method is the mini-emulsion method.

In the polymerizing step, it is preferable to employ a so-called multi-step polymerization method in which the polymerization reaction is carried out in multiple separate steps to obtain composite resin particles composed of resins having different molecular distributions, with a molecular weight gradient formed toward the surface layer of each particle. By employing the multi-step polymerization method, the compressive strength of a toner as a final product can be easily controlled to a predetermined range.

The term “composite resin particle” is intended to mean a resin particle having a multi-layer structure which is constituted by a core resin particle covered by one or more resins covering layers each different from the resin of the core particle in the molecular weight and/or the composition thereof.

The term “multi-step polymerization method” is intended to means a method in which a monomer (n+1) is polymerized (n+1 step) in the presence of a resin particle (n) prepared by polymerizing a monomer (n) to form a covering layer (n+1) comprising a polymer of the monomer (n+1) which is different from the resin of the resin particle (n) in the dispersed situation and/or the composition, on the resin particle (n). When the resin particle (n) is the core particle (n=1), the polymerization is the two-step polymerization, and when the resin particle (n) is a composite resin particle (n≧2), the polymerization is the three or more multi-step polymerization.

Preferred as the multi-step polymerization is the three-step polymerization method for producing a composite resin particle comprised of a central portion (core) comprising a high molecular weight resin, an intermediate layer comprised of a medium molecular weight resin and containing a releasing agent, and an outer layer (shell) comprised of a low molecular weight resin.

In the toner formed by toner particles obtained by the three-step polymerization method, the release agent can be finely and uniformly dispersed by causing the release agent to be contained only in the intermediate layer comprised of the medium molecular weight, and at the same time, the toner as the final product can be formed such that it has a sufficient durability suitable for use as the non-magnetic single component developer.

Further, by decreasing the molecular weight of resins forming respective layers from the central layer toward the outer layer, it is possible to obtain a desired compressive strength.

The two-step polymerizing method in a concrete form is as follows: First, a monomer solution prepared by dissolving a releasing agent in a polymerizable monomer (H) is dispersed in a water-base medium (an aqueous solution of a surfactant) in a form of oil droplets, and the system is subjected to a polymerization process (first polymerization step), to thereby prepare a liquid suspension of resin particles (high molecular weight resin (H)) composed of a resin (polymer of the polymerizable monomer (H)) containing the releasing agent. Then, to the obtained suspension of the resin articles, a polymerization initiator and a polymerizable monomer (L) to form the low molecular weight resin are added, and the polymerizable monomer (L) is subjected to a polymerization process (second polymerization step) to form a covering layer (L) composed of the low molecular weight resin (polymer of the polymerizable monomer (L)) onto the surface of each resin particle (H).

Thus, the composite resin particles are produced each of which is comprised of the central portion (core) composed of the high molecular weight resin containing the release agent, and the outer layer (shell) composed of the low molecular weight resin.

The molecular weight of resin particles can be adjusted by a known method of adding a chain transfer agent, which is easy and convenient to conduct. Other methods can be also employed, including a method of raising the temperature for the polymerization process, a method of using an increased amount of a polymerization initiator.

The three-step polymerizing method in a concrete form is as follows: First, a dispersion of resin particles (H) prepared by a polymerization process (first polymerization step) according to a usual procedure is added to a water-base medium (aqueous solution of a surfactant), and a monomer solution prepared by dissolving a release agent in a polymerizable monomer (M) is dispersed in the water-base medium in a form of oil droplets. Then, the aqueous dispersion system is subjected to a polymerization process (second polymerization step) to form a covering layer (M) (intermediate layer) comprising a resin (polymer of the polymerizable monomer M) containing the release agent onto the surface of each resin particle (H) (core particle). Thus a dispersion of composite resin particles (high molecular weight resin (H)-low molecular weight resin (L)) is prepared. Next, to the obtained suspension of the composite resin articles, a polymerization initiator and a polymerizable monomer (L) to form the low molecular weight resin are added, and the polymerizable monomer (L) is subjected to a polymerization process (third polymerization step) to form a covering layer L composed of the low molecular weight resin (polymer of the monomer L) onto the surface of each composite resin particle.

Thus, the composite resin particles are produced each of which is comprised of the central portion (core) composed of the high molecular weight resin, the intermediate layer containing the release agent, and the outer layer (shell) composed of the low molecular weight resin.

(4) Salting-Out/fusing Step

In the salting-out/fusing step, a liquid dispersion of colorant particles is added to the liquid dispersion of the resin particles obtained in the polymerizing step, thereby salting-out/fusing the resin particles and the colorant particles in the water-base medium.

Further, in the salting-out/fusing step, not only the resin particles and the colorant particles but also internal additive particles (fine particles having a mass average primary particle diameter of approximately 10 to 1000 nm) e.g. of a charge-controlling agent can be fused.

Now, the term “salting-out/fusing” is intended to mean simultaneous occurrence of salting-out (aggregation of particles) and fusing (extinction of interfaces between particles), or action for causing salting-out and fusing to occur simultaneously. To cause the salting-out and the fusing to occur at the same time, it is required to aggregate particles (resin particles, colorant particles) at a temperature equal to or higher than a glass transition temperature (Tg) of a resin constituting resin particles.

In the salting-out/fusing step, the term “water-base medium” is intended to mean a medium mainly composed of water (50 mass % or more). The components other than water include water-soluble organic solvents, such as methanol, ethanol, isopropanol, butanol, acetone, methyl ethyl ketone, and tetrahydrofuran. Out of the above organic solvents, alcohol-based organic solvents, such as methanol, ethanol, isopropanol, butanol, which do not dissolve any resins, are particularly preferable.

The liquid dispersion of the resin particles used in the salting-out/fusing step can be obtained by a method of repeatedly dispersing resin particles by using energy made uniform through mechanical dispersion of the resin particles by a pressure dispersing machine, such as the mechanical dispersing apparatus “CLEARMIX” (available from M Technique Co., Ltd.), the ultrasonic wave dispersing machine, the mechanical homogenizer, Manton Gaulin, or the pressure-type homogenizer. It should be noted that the mass average primary particle diameter of resin particles is a resin particle diameter measured by using an electrophoretic light scattering spectrophotometer “ELS-800” (available from Otsuka Electronics Co., Ltd.).

It is preferable that the liquid dispersion of resin particles for use in the salting-out/fusing step has a degree of dispersion of a mass average primary article size indicative of a particle diameter of the resin particles, which is 20% or less in terms of CV value (variation coefficient obtained by dividing a standard deviation by an average particle diameter) indicative of a particle diameter distribution. To obtain such a dispersion property, it is possible to employ a method of repeatedly dispersing resin particles by using energy made uniform through mechanical dispersion of the resin particles by a pressure dispersing machine, such as the mechanical dispersing apparatus “CLEARMIX” (available from M Technique Co., Ltd.), the ultrasonic wave dispersing machine, the mechanical homogenizer, Manton Gaulin, or the pressure-type homogenizer. It should be noted that the mass average primary particle diameter of resin particles is a resin particle diameter measured by using an electrophoretic light scattering spectrophotometer “ELS-800” (available from Otsuka Electronics Co., Ltd.).

The liquid dispersion of the colorant particles used in the salting-out/fusing step can be prepared by dispersing the colorant in a water-base medium. The colorant-dispersing process is carried out in the water in a state where the concentration of the surfactant has been made equal to or higher than the critical micelle concentration (CMC).

Although the dispersing machine used in the colorant-dispersing process is not particularly limited, it is preferable to employ a dispersing machine which generates a shearing force by a screen defining a stirring chamber, and a rotor rotating in the stirring chamber at a high speed, and finely disperses the colorant in the water-base medium containing the surfactant by action of the shearing force (further, by action of collision force, changes in pressure, cavitation, and potential core), thereby forming fine particles. Examples of such a machine include pressure dispersing machines, such as the mechanical dispersing apparatus “CLEARMIX” (available from M Technique Co., Ltd.), the ultrasonic wave dispersing machine, the mechanical homogenizer, Manton Gaulin, and the pressure-type homogenizer, and medium-type dispersing machines, such as a sand grinder, Getzmann Mill, and Diamond Fine Mill. Further, the same surfactant as enumerated above can be used in the salting-out/fusing step.

The colorant particles have a mass average particle diameter (dispersed particle diameter) of 30 to 500 nm, preferably 50 to 300 nm.

When the mass average particle diameter of the fine particles of the colorant is smaller than 30 nm, the floating of colorant particles in the water-base medium is increased, and when the mass average particle diameter exceeds 500 nm, the colorant particles are not properly dispersed in the water-base medium and made liable to settle out, so that it is sometimes difficult to introduce the colorant into the toner particles. Under such conditions, the colorant particles unfavorably remain free in the water-base medium without being taken into the toner particles. It should be noted that the mass average particle diameter of the fine particles of the colorant is measured by using the electrophoretic light scattering spectrophotometer “ELS-800” (available from Otsuka Electronics Co., Ltd.).

In the salting-out/fusing step, a salting-out agent comprised of a metal salt is added to a water-base medium in which resin particles and colorant particles are present, as an aggregating agent to a concentration not lower than a critical aggregation concentration, and then the water-base medium is heated to a temperature equal to or higher than a glass transition temperature of the resin particles, whereby salting out and fusing of the resin particles and the colorant particles are caused to proceed at the same time. In this step, an organic solvent that is infinitely soluble in water may be added.

Examples of the aggregating agent include metal salts formed from alkali metals (monovalent metals), such as sodium, potassium, and lithium, metal salts formed from alkaline earth, such as calcium and magnesium, and bivalent metals, such as manganese and copper, and metal salts formed from trivalent metals, such as iron and aluminum, but it is preferable to use the metal salts formed from the bivalent or trivalent metals, since the metal salts formed from the bivalent and trivalent metals have a smaller critical aggregation concentration (coagulation value, coagulation point) than that of the metal salts formed from the monovalent metals.

The above metal salts can be used alone or in combination of two or more.

Examples of the aggregating agent include sodium chloride, potassium chloride, lithium chloride, calcium chloride, zinc chloride, copper sulfate, magnesium sulfate, manganese sulfate, aluminum chloride, and iron chloride.

Although the aggregating agent is only required to be added such that the concentration of the aggregating agent is not lower than the critical aggregation concentration, the aggregating agent is preferably added such that the concentration of the aggregating agent becomes equal to or higher than 1.2 times the critical aggregation concentration, more preferably 1.5 times the critical aggregation concentration.

It is arbitrarily selected whether the metal salt is added to the water-base medium in which the resin particles and the colorant particles are present, directly or in the form of aqueous solution thereof, but when the metal salt is added in the form of the aqueous solution thereof, it is necessary that the concentration of the added metal salt is equal to or higher than the critical aggregation concentration, with respect to a total volume of the water-base medium and the aqueous solution of the metal salt.

The term “critical aggregation concentration” is intended to mean an index concerning stability of an aqueous dispersed material, that is, the concentration of the aggregating agent at which aggregation due to addition of the aggregating agent occurs.

The critical aggregation concentration is largely changed depending on an emulsified component and a dispersant itself. For example, it is possible to accurately determine a critical aggregation concentration by a method described e.g. in Seizo Okamura, et. al “Polymer Chemistry” (17, 601 (1960): compiled by the Society of Polymer Science, Japan. Further, another method can be employed in which a desired kind of salt is added to a liquid dispersion of target particles while changing a resultant salt concentration of the dispersion, and ξ electric potential of the dispersion is measured, whereby it is possible to determine a salt concentration at which the value of the ξ electric potential is changed, as the critical aggregation concentration.

Examples of the above organic solvent which is infinitely soluble in water include methanol, ethanol, 1-propanol, 2-propanol, ethylene glycol, glycerin, and acetone, but alcohols having 3 or less carbon atoms, such as methanol, ethanol, 1-propanol, and 2-propanol are preferable, and 2-propanol is particularly preferable.

In the salting-out/fusing step, assuming that the glass transition temperature of a resin as the material of the resin particles is represented by Tg, the temperature suitable for the salting-out/fusing process is in a range of (Tg+10° C.) to (Tg+50° C.), particularly preferably in a range of (Tg+15° C.) to (Tg+40° C.). It should be noted that the fusion can be effectively conducted by adding the organic solvent which is infinitely soluble in water, to the system processed in the salting-out/fusing step.

Further, in the present invention, the separation of toner particles obtained by salting-out/fusing of resin particles and colorant particles in a water-base medium, from the water-base medium is preferably carried out at a temperature equal to or higher than a Krafft point of a surfactant present in the water-base medium, preferably in a temperature range of Krafft point+20° C.

The “Krafft point” is a temperature at which an aqueous solution containing a surfactant starts to become whitish, and measured by adding an amount of flocculant to be actually used to a water-base medium used in a salting-out, aggregating, and fusing step (salting-out/fusing step in the present invention), i.e. a surfactant solution, storing the thus prepared solution at 1° C. for 5 days, and then gradually heating this solution with stirring until the solution becomes transparent.

Further, in the salting-out/fusing step, it is important to continue the salting-out/fusing process by holding the temperature of the liquid dispersion of the resin particles and the colorant particles for a predetermined time period, after the temperature of the dispersion has reached a temperature equal to or higher than the glass transition temperature. This makes it possible to effectively cause the growth of the toner particles (aggregation of resin particles and colorant particles), and the fusion thereof (extinction of interfaces between the particles) to proceed, thereby making it possible to enhance durability of a toner as a final product.

Further, it is preferable to carry out aging treatment by continuing the fusion by heating the dispersion, after stopping the growth of associated particles.

The aging treatment is a process in which the temperature of a system in which the growth of associated particles has been stopped is held at a temperature 10 to 40° C. higher than a glass transition temperature of a resin forming an outermost layer of each associated particle, and stirring of the system with a predetermined intensity is continued. By carrying out the aging treatment, the adhesion between toner particles can be increased to thereby control the compressive strength of a toner as a final product to a value within a predetermined range.

If the aging treatment is carried out at an excessively high treatment temperature, there is a fear that the compressive strength of the toner obtained becomes too large. Therefore, it is necessary to properly set the treatment temperature and treatment time period.

In concrete, the aging treatment is normally carried out at a treatment temperature of 70 to 100° C., for a treatment time period of 120 to 600 minutes.

(5) Filtering/Washing Step

In the filtering/washing step, there are carried out a filtering process for separating the toner particles from the liquid dispersion thereof obtained through the above steps, by filtration, and a washing process in which attached substances, such as the surfactant and the salting-out agent are removed from the toner particles (cake-like aggregate) separated from the dispersion by filtration.

The method of the filtration includes, for example, a centrifugation method, a vacuum filtering method carried out using a nutsche or the like, and a filtering method carried out using a filter press or the like, but not particularly limited thereto.

(6) Drying Step

This step is carried out to dry the toner particles washed in the washing step.

Examples of the drier used in the drying step include spray driers, vacuum freeze driers, and vacuum driers, and it is preferable to use standing tray dryers, movable tray dryers, fluidized-bed layer dryers, rotary dryers, stirring dryers, and the like.

The moisture content of the dried toner particle is preferably 5 mass % or less, more preferably 2 mass % or less.

Further, when the dried toner particles are aggregated to each other by a weak interparticle attracting force, the aggregate may be crushed. As a crushing machine, it is possible to use a mechanical crushing apparatus, such as a jet mill, the Henschel mixer, a coffee mill, and a food processor.

(7) External Additive-Adding Step

This step is for adding an external additive to the dried toner particles.

Examples of an apparatus for use in adding an external additive include a Turbula mixer, a Henschel mixer, a Nauter Mixer, a V-type mixer, and various other know mixers.

The toner according to the present invention may be additionally comprised of not only the colorants and the release agent but also materials capable of imparting various capabilities to the toner. One example of such a material is a charge-controlling agent. Such materials can be added by various methods including a method in which the material(s) is/are added together with the resin particles and the colorant particles in the fusing step, so as to cause them to be contained in the toner, and a method of adding the material(s) to the resin particles themselves.

Similarly, it is possible to use various types of known charge-controlling agents which can be dispersed in water. Examples of the charge-controlling agents include nigrosine dye, metal salts of naphthenic acid or higher fatty acids, alkoxylated amines, quaternary ammonium salt compounds, azo metal complexes, metal salts of salicylic acid and metal complexes thereof.

To the toner according to the invention, it is possible to add so-called external additives with a view to improving flowability, electrostatic chargeability, and a cleaning property. These external additives are not particularly limited, but it is possible to use various inorganic fine particles, organic fine particles, and slip additives. However, it is preferable to use external additives of inorganic fine particles having an average primary particle diameter of 30 to 500 nm.

The toner according to the present invention is a so-called associated-type toner obtained by carrying out the step of salting-out and fusing resin particles and colorant particles in a water-base medium. The toner has a specific compressive strength and a standard deviation thereof, and therefore it is possible to obtain an excellent image formability and high toughness. This makes it possible to suppress attachment of toner stains caused by breaking or chipping of toner particles to components of the image forming device, in a step of giving a necessary amount of electric charge to the toner. As a result, it is possible to obtain a high-quality image over a long time period.

Therefore, according to the toner of the present invention, it is possible to stably obtain a high-quality image by the non-magnetic single component development system.

The method of obtaining a toner having predetermined properties is not particularly limited, but it is possible to appropriately obtain a desired toner by carrying out the following controls (1) to (3):

(1) In the polymerizing step, to control the structure of resin particles to be obtained, by a multi-step polymerization method, i.e. which is executed in three or more steps.

(2) In obtaining resin particles by the three or more-step polymerization method in the polymerizing step, to control the respective molecular weights of resins forming layers of the particles, such that the molecular weight is decreased from the central portion to the surface layer.

(3) After carrying out the associating process by the salting-out/fusing method, to control at least one of a time period required for executing the aging treatment in which associated particles obtained by the associating process are stirred and a temperature condition in the aging treatment.

The toner described hereinbefore can be suitably used as a non-magnetic single component developer, and particularly as a toner for forming color images.

According to the image forming method using the non-magnetic single component developer, an electrostatic latent image formed on a surface of an electrostatic latent image carrier is developed by the non-magnetic single component development system using a toner transferred and carried by a toner carrier with which a toner layer limiting member for limiting the amount of the toner on the surface of the toner carrier has been brought into pressure contact, then the toner forming a toner image which is visualized by the development on the surface of the electrostatic latent image carrier, is transferred to an image support (hereinafter referred to as the “recording member”), such as paper, and the transferred toner is thermally fixed, whereby a visible image is formed on the recording member.

As the toner for a non-magnetic single component full-color development, which is used for forming an image comprised of a yellow toner (Y), a magenta toner (M), a cyan toner (C), and a black toner (K), a toner is preferable which is obtained by carrying out a step of salting-out/fusing resin particles and colorant particles in a water-base medium, and has a compressive strength of 14 to 20, and a standard deviation of the compressive strength of smaller than 1, as well as a number average particle diameter of 3 to 9 μm, an average circularity of 0.955 to 0.990, a standard deviation of the average circularity of not larger than 0.040.

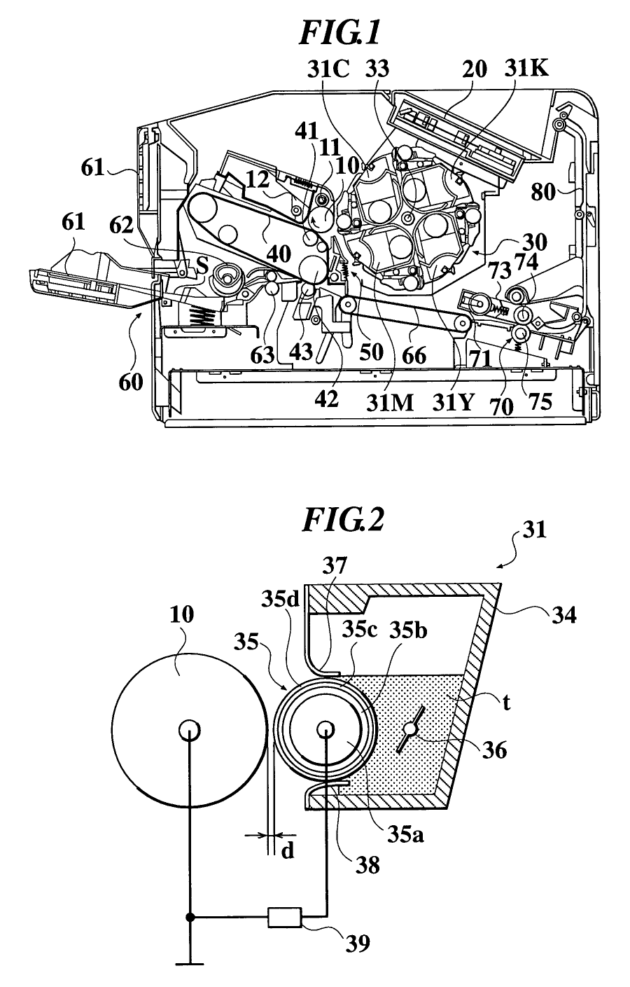

FIG. 1 is a diagram schematically showing an example of the arrangement of an image forming apparatus used in the present invention.

The image forming apparatus is comprised of an electrostatic latent image carrier (hereinafter simply referred to as “the image carrier”) 10 formed by a photoreceptor drum rotating clockwise as viewed in FIG. 1 (in a direction indicated by an arrow in FIG. 1), a charging brush 11 for uniformly charging a surface of the image carrier 10 to a predetermined potential, an optical laser scanning system 20 which contains, for example, a laser diode, a polygon mirror, and an fθ optical element, and executes scanning exposure by a laser beam to thereby form an electrostatic latent image on the surface of the image carrier 10 based on image information of an image to be formed on the image carrier 10 uniformly charged, a developing device 30 for developing the electrostatic latent image formed on the surface of the image carrier 10 to thereby form a toner image, an endless intermediate transfer belt 40 to which the toner image formed on the image carrier 10 is primarily transferred by urging operation of a primary transfer roller 41, a secondary transfer roller 43 for transferring the primary transfer toner image primarily transferred on the intermediate transfer belt 40 onto a recording member S, such as paper, by urging operation thereof, at a portion of the intermediate transfer belt 40, supported by a support roller 42, and a fixing device 70 that includes a heating roller 71 formed by a tension roller provided with a halogen heater, a fixation belt 73 stretched around a fixation roller 74 formed by a drive roller, and a pressure roller 75 brought into pressure contact with the fixation roller 74 via the fixation belt 73, and fixes the toner image transferred on the surface of the recording member S.

In FIG. 1, reference numeral 12 designates cleaning means for scraping off toner remaining on the image carrier 10, reference numeral 50 designates cleaning means for scraping off toner remaining on the intermediate transfer belt 40, reference numeral 60 designates paper supply means for guiding the recording member S to the intermediate transfer belt 40, reference numeral 66 designates feeding means for feeding the recording member S having a secondary transfer toner image formed thereon to the fixing device 70, and reference numeral 80 designates an perpendicular feeding passage for feeding a recording member S having a toner image fixed thereon to an exit.

The paper supply means 60 is comprised of a paper supply tray 61 for containing recording members S therein, a paper supply roller 62 for supplying the recording members S contained in the paper supply tray 61 one by one, and a timing roller 63 for feeding each recording member S supplied in synchronism with formation of a primary transfer toner image on the intermediate transfer belt 40, between the intermediate transfer belt 40 and the secondary transfer roller 43.

The developing device 30 is a full color developing device for supplying respective toners (non-magnetic single component developers) of cyan, magenta, yellow, and black to the image carrier 10 having an electrostatic latent image formed thereon to thereby carry out full color development. The developing device 30 has four color-specific developing units 31C (for cyan), 31M (for magenta), 31Y (for yellow), and 31K (for black), arranged around a support shaft 33, for holding respective toners of the four colors, and is configured such that the developing units 31C, 31M, 31Y, 31K are rotated about the support shaft 33, for being guided to respective positions opposed to the image carrier 10.

Hereinafter, the developing units 31C, 31M, 31Y, 31K forming the developing device 30 will be described with reference to FIG. 2. The developing units 31C, 31M, 31Y, 31K are constructed similarly to each other.

FIG. 2 is an explanatory cross-sectional view useful for explaining the arrangement of each developing unit of the developing device 30 of the FIG. 1 image forming apparatus. In FIG. 2, the developing unit is shown in a simplified manner.

The developing unit 31 includes a developing unit body 34 for accommodating components of the developing device 30 and a toner t, a toner carrier 35 arranged in a manner opposed to the image carrier 10 with a predetermined distance d therefrom, a feed member 36 for supplying toner to the toner carrier 35, a toner layer limiting member (hereinafter simply referred to as “the limiting member”) 37 that limits the amount of toner transferred and carried on a surface of the toner carrier 35, and at the same time acts to cause frictional charge on the toner transferred and carried on the toner carrier 35, a static eliminator 38 for eliminating static electricity from toner remaining on the surface of the toner carrier 35 after development, and a development bias power supply 39.

In the developing unit 31, when the toner carrier 35 rotates, the toner contained in the developing unit body 34 is supplied to the toner carrier 35 by the feed member 36, and the limiting member 37 is brought into pressure contact with the surface of the toner carrier 35 in this state, whereby the amount of toner transferred and carried on the surface of the toner carrier 35 is limited, and at the same time the toner is charged by friction.

Then, when the toner, which is carried on the surface of the toner carrier 35 bearing a required amount of electric charge generated by the frictional charge, is guided to a developing area opposed to the image carrier 10 with the predetermined distance d therefrom, the toner carried on the surface of the toner carrier 35 is caused to fly between the toner carrier 35 and the image carrier 10 by action of an alternating electric field generated between the toner carrier 35 and the image carrier 10 when an alternating voltage is applied by the development bias power supply 39, and an electrostatic latent image formed on the image carrier 10 is developed by the toner.

Further, when the toner is brought into contact with the static eliminator 38, static electricity is eliminated from the toner remaining on the surface of the toner carrier 35 after development, whereby the toner is separated from the surface of the toner carrier 35, and returned to the inside of the developing unit body 34.

It is preferable to use a toner carrier 35 whose surface has an arithmetic average roughness Ra of 0.8 to 2.5 μm, and at the same time a ten-point average roughness Rz of 0.5 to 15.0.

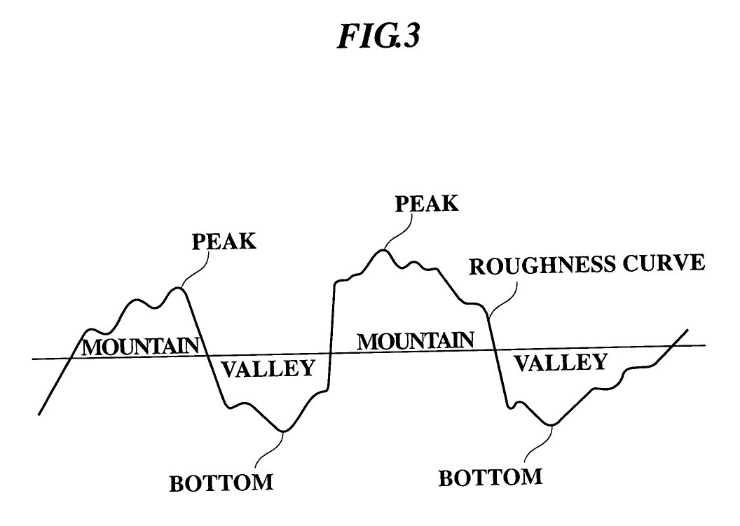

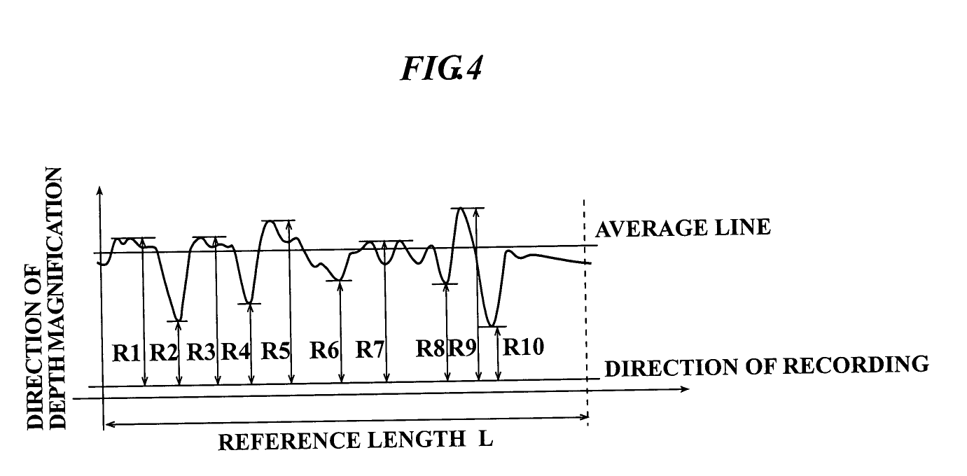

Now, the term “ten-point average roughness Rz” is intended to mean an average roughness measured by the method defined in JIS-B0601-1982, and calculated by Eequation (2) shown below: Referring to FIG. 3 and FIG. 4, the ten-point average roughness Rz represents, with respect to a portion of the roughness curve over a reference length, an average altitude difference in μm between an average value of altitudes of the highest peak to the fifth highest peak measured from a straight line parallel to an average line and at the same time not crossing the roughness curve, in a direction of depth magnification, and an average value of altitudes of the deepest bottom to the fifth deepest bottom measured from the straight line in the same direction.

Now, the term “roughness curve” is intended to mean a curve indicative of a contour of cross-section of a portion of the toner carrier obtained by cutting off a surface undulation component longer than a wavelength of 0.8 mm from the curve (contour appearing in an cut when a material to be measured is cut off) having the reference length. The term “reference length” represents a predetermined length of the portion of the toner carrier from which the curve indicative of the contour of the cross-section of the toner carrier is taken out. In the present invention, the reference length is set to 2 mm. The term “average line” represents a curved line of a surface to be measured of the portion taken out as the roughness curve, and at the same time set such that the sum of squares of differences between the line and the roughness curve is minimized. The term “peak” represents a portion of a mountain of the roughness curve, having a highest altitude. The term “bottom” represents a portion of a valley of the roughness curve, having a lowest altitude.

$$Rz = \frac{\begin{matrix}( R1 + R3 + R5 + R7 + R9 ) - \\ ( R2 + R4 + R6 + R8 + R10 )\end{matrix}}{5} \qquad ( 2 )$$

where L is a reference length (2 mm), R1+R3+R5+R7+R9 is the altitudes of highest peak to fifth highest peak of a taken out portion corresponding to the reference line L, and R2+R4+R6+R8+R10 is the altitudes of the deepest bottom to the fifth deepest bottom of a taken out portion corresponding to reference line L.

To adjust the ten-point average roughness Rz to a predetermined range, there may be employed a method of adding a filler for controlling the magnitude of Rz e.g. to a coating liquid, referred to hereinafter, to be coated on a surface layer. Inorganic fine particles e.g. of titanium oxide or silica, and fine resin particles e.g. of polymethyl methacrylate or nylon can be used as fillers. The ten-point average roughness Rz on the surface of the toner carrier can be variously controlled depending on the size of the filler. Further, to increase the ten-point average roughness Rz, a method of increasing the amount of filler added may be employed.

When the arithmetic average roughness Ra on the toner carrier 35 exceeds 0.8 μm, the amount of toner taken in by the toner carrier 35 is large, which reduces electrostatic chargeability in a limiting section for limiting the amount of toner, using the toner layer limiting member, so that there is a fear of fogging being caused due to defective charge. On the other hand, when the arithmetic average roughness Ra on the surface of the toner carrier 35 is smaller than 0.8 μm, the amount of toner taken in by the toner carrier 35 is small, so that there is a fear of unevenness of an image and faulty following operation being liable to occur.

When the ten-point average roughness Rz on the toner carrier 35 is smaller than 5.0, latitude in image leakage and unevenness of density in the developing step can be narrowed, whereas when the ten-point average roughness Rz in the toner carrier 35 exceeds 15.0, the latitude in image leakage and unevenness of density in the developing step are widened, but this necessitates increase in the capacity of high voltage power supply, which can result in an increase in manufacturing costs of the toner.

Further, the toner carrier 35 is configured such that an elastic layer 35b, an intermediate layer 35c, and a surface layer 35d are laminated in the mentioned order on a surface of a conductive substrate 35a formed by a metal roller. It is preferable that a volume resistitivity σ1 of the elastic layer 35b, a volume resistitivity σ2 of the intermediate layer 35c, and a volume resistitivity σ3 of the surface layer 35d satisfy a predetermined condition of σ2≦σ1≦σ3.

When the volume resistitivities of the elastic layer 35b, the intermediate layer 35c, and the surface layer 35d constituting the toner carrier 35 satisfy the predetermined condition, even if there exists a variation in the volume resistitivity σ1 of the elastic layer, the variation is lessened by the intermediate layer 35c having a smaller volume resistitivity than the volume resistitivity σ1, and further due to provision of the surface layer 35d having a larger volume resistitivity than the volume resistitivity σ1, the toner carrier 35 comes to have a proper volume resistitivity as a whole. This makes it possible to suppress generation of unevenness in the alternating electric field acting between the toner carrier 35 and the image carrier 10.

Further, also even when a small particle diameterd toner having a number average particle diameter of 3-9 μm or less is used as a non-magnetic single component developer, it is possible to obtain an excellent image suppressed in generation of unevenness of density.

As the elastic layer 35b, there can be used a layer which is formed by adding fine particles of a conductive agent, such as Ketjen black, acetylene black, furnace black, titanium black, or metal oxides, to an elastic material formed e.g. of silicone rubber, isoprene rubber, butadiene rubber, butyl rubber, chloroprene rubber, nitrile rubber, styrene-butadiene rubber, acrylic rubber, ethylene-propylene rubber, ethylene-propylene-diene rubber, urethane rubber, fluororubber, thermoplastic elastomers, or the like.

Preferably, the elastic layer 35b has a volume resistitivity σ1 of 1×10⁴ to 1×10⁶ Ω·M.

When the volume resistitivity σ is too small, moldability of the elastic layer 35b can be reduced, whereas when the volume resistitivity σ1 is too large unevenness of the volume resistitivity can be increased in the elastic layer.

Further, the elastic layer 35b has a thickness of 0.3 to 1.5 mm, preferably 0.5 to 1.0 mm, and a hardness of 5 to 60 degrees, preferably 10 to 50 degrees according to the JIS-A hardness.

As the intermediate layer 35c, there can be used a layer which is formed by adding any of the same conductive agents as used in forming the elastic layer 35b, e.g. to silicone rubber, isoprene rubber, butadiene rubber, butyl rubber, chloroprene rubber, nitrile rubber, styrene butadiene rubber, acrylic rubber, ethylene-propylene rubber, urethane rubber, epichlorohydrin rubber, silicone resin, acrylic resin, polyester resin, ABS resin, styrene resin, urethane resin, or the like.

It is preferable that the intermediate layer 35c has a volume resistitivity σ2 of 1×10⁴ Ω·m or less. If the volume resistitivity σ2 of the intermediate layer 35c is within this range, it is possible to adjust the volume resistitivity σ1 of the elastic layer 35b to the predetermined range.

The intermediate layer 35c has a thickness of 5 to 30 μm, preferably 10 to 25 μm.

As the surface layer 35d, there can be used a layer which is formed by adding any of the same conductive agents as used in forming the elastic layer 35b, e.g. to silicone rubber, butadiene rubber, chloroprene rubber, nitrile rubber, acrylic rubber, urethane rubber, silicone resin, acrylic resin, urethane.

Preferably, the surface layer 35d has a volume resistitivity σ3 of 1×10⁶ to 1×1012 Ω·m.

When the volume resistitivity σ3 is too small, leakage is liable to occur when the alternating electric field is caused to act between the toner carrier 35 and the image carrier 10 so as to perform development, whereas when the volume resistitivity σ3 is too large, the alternating electric field caused to act between the toner carrier 35 and the image carrier 10 is reduced in strength, which can make it impossible to supply sufficient toner to an image portion of the image carrier 10.

Further, the surface layer 35d has a thickness of 5 to 40 μm, preferably 10 to 30 μm.

The toner carrier 35 constructed as above can be formed, for example, by setting the conductive substrate 35a in an elastic layer forming mold, injecting an elastic layer coating liquid around the periphery of the conductive substrate 35a in the mold and curing the liquid, removing the mold to form an elastic layer 35b on the peripheral surface of the conductive substrate 35a, coating an intermediate layer coating liquid on a surface of the formed elastic layer 35b and drying the liquid to form an intermediate layer 35c, and further coating a surface layer coating liquid on a surface of the formed intermediate layer 35c and drying the liquid to form a surface layer 35d. Thus, it is possible to produce the toner carrier 35 having the elastic layer 35b, the intermediate layer 35c, and the surface layer 35d laminated in the mentioned order on the surface of the conductive substrate 35a.

### EXAMPLE

Now, Examples of the present invention will be described. Of course, the present invention is not limited to these Examples.

### Preparation Example 1 of Resin Particles

(1) Formation of Core Particles (First Polymerization Step)

A separable flask having a capacity of 5000 ml and equipped with a stirring device, a temperature sensor, a cooling pipe, and a nitrogen-introducing device was charged with a surfactant solution (water-base medium) obtained by dissolving 7.08 g of anionic surfactant (hereinafter referred to as “anionic surfactant (1)) expressed by the above formula (a) in 3010 g of deionized water, and the internal temperature was raised to 80° C., with stirring at a stirring speed of 230 rpm under a nitrogen gas stream.

To the surfactant solution, an initiator solution obtained by dissolving 9.2 g of a polymerization initiator (potassium persulfate: KPS) in 200 g of deionized water was added, and after the temperature was set to 75° C., a monomer solution consisting of 7.01 g of styrene, 19.9 g of n-butyl acrylate, and 10.9 g of methacrylic acid was added dropwise over one hour. The resulting system was heated at 75° C. with stirring for two hours to thereby conduct polymerization reaction (reaction of the first step polymerization), to prepare a dispersion of resin particles composed of a high molecular weight resin (hereinafter referred to as “Latex (1H)”.

(2) Formation of Intermediate Layer (Second Polymerizing Step)

In a flask equipped with a stirring device, 98.0 g of a compound represented by the above formula (W19) (hereinafter referred to as “Exemplified compound (W19)”) was added to a monomer mixture solution consisting of 105.6 g of styrene, 30.0 g of n-butyl acrylate, 6.2 g of methacrylic acid, and 5.6 g of n-octyl-3-mercaptopropionate and the resulting mixture was heated to 90° C. to dissolve the Exemplified compound to thereby prepare a monomer solution.

On the other hand, a flask equipped with a stirring device was charged with a surfactant solution (water-base medium) obtained by dissolving 1.6 g of the anionic surfactant (1) in 2700 ml of deionized water, and the internal temperature was raised to 98° C. Then, the Latex (1H) obtained by the first polymerization step was added in an amount of 28 g in terms of solid content.

Then, the monomer solution was mixed and dispersed in the surfactant solution containing the Latex (1H) by using a mechanical dispersing apparatus “CLEARMIX” (available from M Technique Co., Ltd.) having a circulation path, whereby an emulsion (dispersion) containing emulsified articles (oil droplets) dispersed with a uniform dispersed particle diameter was prepared.

After that, an initiator solution prepared by dissolving 5.1 g of polymerization initiator (KPS) in 240 ml of deionized water and 750 ml of deionized water were added to the dispersion (emulsified liquid), and the resulting system was heated with stirring at 98° C. for 12 hours, whereby polymerization reaction (reaction of the second polymerization step) was conducted to prepare a dispersion of composite resin particles (hereinafter referred to as “Latex 1HM”) having a structure in which surfaces of resin particles of high molecular weight resin are covered with medium molecular weight resin containing the exemplified compound (W19).

Incidentally, after the Latex (1HM) obtained was dried, particles forming the same were observed by a scanning electron microscope, whereby it was confirmed that there were particles (particle diameter of 400 to 1000 nm) mainly composed of the exemplified compound (W19) in addition to the composite resin particles.

(3) Formation of Outer Layer (Third Polymerization Step)

To the obtained Latex (1HM) charged in a flask equipped with a stirring device, an initiator solution prepared by dissolving 7.4 g of a polymerization initiator (KPS) in 200 ml of deionized water was added, and while holding the temperature at 80° C., a monomer mixture liquid consisting of 300 g of styrene, 95 g of n-butyl acrylate, 15.3 g of methacrylic acid, and 10.4 g of n-octyl-3-mercaptopropionate was added dropwise over one hour, and the resulting system was heated with stirring at 80° C. for two hours, to thereby conduct polymerization reaction (third polymerization step). After that, this system was cooled down to 28° C., to thereby prepare a dispersion latex (hereinafter also referred to as “Latex (1HML)”) of composite resin particles having a structure in which the surface of each resin particle of high molecular weight is covered with medium molecular weight resin, and further, the surface of an intermediate layer of the medium molecular weight resin is covered with low molecular weight resin.

It was confirmed that the composite resin particles forming the obtained Latex (1HML) had a weight average particle diameter of 122 nm, and the resin forming the composite resin particles had three peaks of molecular weight at 138,000, 80,000, and 13,000.

### Preparation Example 2 of Resin Particles

A dispersion Latex (hereinafter referred to as “Latex (2HML)”) of composite resin particles each composed of the core particle, the intermediate layer, and the outer layer was prepared in the same manner as in Preparation Example 1 of Resin Particles except that 7.08 g of sodium dodecyl benzene sulfonate (SDS: anionic surfactant) was used in place of 7.08 g of the anionic surfactant (1) in the step of forming core particles in Preparation Example 1.

It was confirmed that the composite resin particles forming the obtained Latex (2HML) had a weight average particle diameter of 110 nm, and the resin forming the composite resin particles had three peaks of molecular weight at 138,000, 80,000, and 12,000.

### Preparation Example 1 of Colorant Dispersion

59.0 g of the anionic surfactant (1) was dissolved in 1600 ml of deionized water, with stirring. While stirring the solution, 420.0 g of carbon black “Mogul 330R” (available from Cabot Corporation) was gradually added to the solution as a colorant, and then dispersed using the mechanical dispersing apparatus “CLEARMIX” (available from M Technique Co., Ltd.), whereby a liquid dispersion of colorant particles (hereinafter referred to as “the colorant dispersion (1)”) was prepared.

A particle diameter of the colorant particles in the obtained colorant dispersion (1) was measured using the electrophoretic light scattering spectrophotometer “ELS-800” (available from Otsuka Electronics Co., Ltd.). The measured particle diameter was 89 nm in weight average particle diameter.

### Preparation Example 2 of Colorant Dispersion

A dispersion of colorant particles (hereinafter referred to as “the colorant dispersion (2)”) was prepared in the same manner as in Preparation Example 1 except that 420.0 g of pigment “C.I. pigment yellow 185” was used in place of 420.0 g of carbon black.

A particle diameter of the colorant particles in the obtained colorant dispersion (2) was measured using the electrophoretic light scattering spectrophotometer “ELS-800” (available from Otsuka Electronics Co., Ltd.). The measured particle diameter was 89 nm in weight average particle diameter.

### Preparation Example 3 of Colorant Dispersion

A dispersion of colorant particles (hereinafter referred to as “the colorant dispersion (3)”) was prepared in the same manner as in Preparation Example 1 except that 420.0 g of quinacridone magenta pigment “C.I. pigment red 122” was used in place of 420.0 g of carbon black.

A particle diameter of the colorant particles in the obtained colorant dispersion (3) was measured using the electrophoretic light scattering spectrophotometer “ELS-800” (available from Otsuka Electronics Co., Ltd.). The measured particle diameter was 89 nm in weight average particle diameter.

### Preparation Example 4 of Colorant Dispersion

A dispersion of colorant particles (hereinafter referred to as “the colorant dispersion (4)”) was prepared in the same manner as in Preparation Example 1 except that 420.0 g of phthalocyanine cyan pigment “C.I. pigment blue 15:3” was used in place of 420.0 g of carbon black.

A particle diameter of the colorant particles in the obtained colorant dispersion (4) was measured using the electrophoretic light scattering spectrophotometer “ELS-800” (available from Otsuka Electronics Co., Ltd.). The measured particle diameter was 89 nm in weight average particle diameter.

### Production Example K1 of Colorant Particles

A reaction vessel (four-neck flack) equipped with a temperature sensor, a cooling pipe, a nitrogen-introducing device, and a stirring device was charged with 420.7 g of the Latex (1HML) (in terms of solid content), 900 g of deionized water, and 166 g of the colorant dispersion (1). After the internal temperature was adjusted to 30° C., 5 N of sodium hydroxide solution was added to the dispersion mixture solution to adjust the pH to 10.0. Then, to the resulting liquid dispersion mixture, a solution prepared by dissolving 12.1 g of magnesium chloride hexahydrate in 1000 ml of deionized water was added with stirring at 30° C. over 10 minutes. The mixture was allowed to stand for 3 minutes, and the temperature of the association system started to be raised up to −90° C. over 10 minutes.

In the above state, particle diameters of associated particles were measured using the “Coulter Counter TA-II”, and when the volume average particle diameter reached 5.2 μm, a solution prepared by dissolving 80.4 g of sodium chloride in 1000 ml of deionized water was added to stop the growth of the particles. Further, the fusing of particles was continued by heating at a liquid temperature of 95° C. for 10 hours with stirring, whereby the aging treatment was conducted. Subsequently, the system was cooled down to 30° C., and hydrochloric acid was added to adjust the pH to 2.0, followed by stopping the stirring operation.

The produced particles were filtered, repeatedly washed by deionized water at 45° C., and then dried by a warm temperature of 40° C., whereby colorant particles (hereinafter referred to as “the colorant particles (K1)”) were obtained.

### Production Example K2 of Colorant Particles

Colorant particles (hereinafter also referred to as “the colorant particles (K2)”) were obtained in the same manner as in Production Example K1 except that 420.7 g (in terms of solid content) of the Latex (2HML) was used in place of the Latex (1HML) (in terms of solid content), the pH of the dispersion mixture was adjusted to 11.0, and the growth of particles was stopped when the number average particle diameter became equal to 5.5 μm.

### Production Examples K3 to K5 of Colorant Particles

Colorant particles (hereinafter also referred to as “the colorant particles (K3) to (K5)”) were obtained in the same manner as in Production Example K1 except that liquid temperature and stirring time under heating for the aging treatment were set to conditions shown in Table 1.

### Production Example K6 of Colorant Particles

Colorant particles (hereinafter also referred to as “the colorant particle K6”) were obtained in the same manner as in Production Example K1 except that 420.7 g of the Latex (1HM) (in terms of solid content) was used in place of 420.7 g of the Latex (1HML) (in terms of solid content), the growth of particles was stopped when the number average particle diameter thereof became equal to 5.4 μm, and the liquid temperature, and stirring time under heating for the aging treatment were set to conditions shown in Table 1.

Production Example Y1 of Colorant Particles P Colorant particles (hereinafter also referred to as “the colorant particle Y1”) were obtained in the same manner as in Production Example K1 except that 166 g of the colorant dispersion (2) was used in place of 166 g of the colorant dispersion (1), the growth of particles was stopped when the number average particle diameter thereof became equal to 5.5 μm, and the liquid temperature, and stirring time under heating for the aging treatment were set to conditions shown in Table 1.

### Production Example Y2 of Colorant Particles

Colorant particles (hereinafter also referred to as “the colorant particle Y2”) were obtained in the same manner as in Production Example Y1 except that 420.7 g of the Latex (2HML) (in terms of solid content) was used in place of 420.7 g of the Latex (1HML) (in terms of solid content), the pH of the dispersion mixture solution was adjusted to 9.0, and the growth of particles was stopped when the number average particle diameter thereof became equal to 5.4 μm.

### Production Examples Y3 to Y5 of Colorant Particles

Colorant particles (hereinafter also referred to as “the colorant particle Y3 to Y5”) were each obtained in the same manner as in Production Example Y1 except that the liquid temperature and the stirring time under heating for the aging treatment were set to conditions as shown in Table 1.

### Production Example Y6 of Colorant Particles

Colorant particles (hereinafter also referred to as “the colorant particle Y6”) were obtained in the same manner as in Production Example Y1 except that 420.7 g of the Latex (1HM) (in terms of solid content) was used in place of 420.7 g of the Latex (1HML) (in terms of solid content), the pH of the disperse mixture solution was adjusted to 11.0, the growth of particles was stopped when the number average particle diameter thereof became equal to 5.6 μm, and the liquid temperature, and stirring time under heating for the aging treatment were set to conditions shown in Table 1.

Production Example M1 of Colorant Particles

Colorant particles (hereinafter also referred to as “the colorant particle M1”) were obtained in the same manner as in Production Example K1 except that 166 g of the colorant dispersion (3) was used in place of 166 g of the colorant dispersion (1), and the growth of particles was stopped when the number average particle diameter thereof became equal to 5.5 μm.

### Production Example M2 of Colorant Particles

Colorant particles (hereinafter also referred to as “the colorant particle M2”) were obtained in the same manner as in Production Example M1 except that 420.7 g of the Latex (2HML) (in terms of solid content) was used in place of 420.7 g of the Latex (1HML) (in terms of solid content), the pH of the dispersion mixture solution was adjusted to 9.0, and the growth of particles was stopped when the number average particle diameter thereof became equal to 5.4 μm.

### Production Examples M3 to M5 of Colorant Particles

Colorant particles (hereinafter also referred to as “the colorant particle M3 to M5”) were each obtained in the same manner as in Production Example M1 except that the liquid temperature and the stirring time under heating for the aging treatment were set to conditions as shown in Table 1.

### Production Example M6 of Colorant Particles

Colorant particles (hereinafter also referred to as “the colorant particle M6”) were obtained in the same manner as in Production Example M1 except that 420.7 g of the Latex (1HM) (in terms of solid content) was used in place of 420.7 g of the Latex (1HML) (in terms of solid content), the pH of the disperse mixture solution was adjusted to 11.0, the growth of particles was stopped when the number average particle diameter thereof became equal to 5.6 μm, and the liquid temperature and stirring time under heating for the aging treatment were set to conditions shown in Table 1.

### Production Example C1 of Colorant Particles

Colorant particles (hereinafter also referred to as “the colorant particle C1”) were obtained in the same manner as in Production Example K1 except that 166 g of the colorant dispersion (4) was used in place of 166 g of the colorant dispersion (1), and the growth of particles was stopped when the number average particle diameter thereof became equal to 5.5 μm.

### Production Example C2 of Colorant Particles

Colorant particles (hereinafter also referred to as “the colorant particle C2”) were obtained in the same manner as in Production Example C1 except that 420.7 g of the Latex (2HML) (in terms of solid content) was used in place of 420.7 g of the Latex (1HML) (in terms of solid content), the pH of the dispersion mixture solution was adjusted to 9.0, and the growth of particles was stopped when the number average particle diameter thereof became equal to 5.4 μm.

### Production Examples C3 to C5 of Colorant Particles

Colorant particles (hereinafter also referred to as “the colorant particle C3 to C5”) were each obtained in the same manner as in Production Example C1 except that the liquid temperature and the stirring time under heating for the aging treatment were set to conditions as shown in Table 1.

### Production Example C6 of Colorant Particles

Colorant particles (hereinafter also referred to as “the colorant particle C6”) were obtained in the same manner as in Production Example M1 except that 420.7 g of the Latex (1HM) (in terms of solid content) was used in place of 420.7 g of the Latex (1HML) (in terms of solid content), the pH of the disperse mixture solution was adjusted to 11.0, the growth of particles was stopped when the number average particle diameter thereof became equal to 5.6 μm, and the liquid temperature and stirring time under heating for the aging treatment were set to conditions shown in Table 1.

TABLE 1

| | | | | | | NUMBER | |
|---|---|---|---|---|---|---|---|
| COLORANT | | | LIQUID | STIRRING TIME | | AVERAGE | |
| PARTICLE | | COLORANT | TEM- | UNDER HEATING | | PARTICLE | |
| NUMBER | LATEX | DISPERSION | PERATURE | (h) | | DIAMETER | |
| COLORANT | LATEX 1 | COLORANT | 95° C. | 10 | hrs | 5.2 | μm |
| PARTICLE K1 | HML | DISPERSION 1 | | | | | |
| COLORANT | LATEX 2 | COLORANT | 95° C. | 10 | hrs | 5.5 | μm |
| PARTICLE K2 | HML | DISPERSION 1 | | | | | |
| COLORANT | LATEX 1 | COLORANT | 85° C. | 10 | hrs | 5.2 | μm |
| PARTICLE K3 | HML | DISPERSION 1 | | | | | |
| COLORANT | LATEX 1 | COLORANT | 85° C. | 6 | hrs | 5.2 | μm |
| PARTICLE K4 | HML | DISPERSION 1 | | | | | |
| COLORANT | LATEX 1 | COLORANT | 99° C. | 10 | hrs | 5.2 | μm |
| PARTICLE K5 | HML | DISPERSION 1 | | | | | |
| (COMPARATIVE) | | | | | | | |
| COLORANT | LATEX 1 | COLORANT | 85° C. | 6 | hrs | 5.4 | μm |
| PARTICLE K6 | HM | DISPERSION 1 | | | | | |
| (COMPARATIVE) | | | | | | | |
| COLORANT | LATEX 1 | COLORANT | 95° C. | 10 | hrs | 5.5 | μm |
| PARTICLE Y1 | HML | DISPERSION 2 | | | | | |
| COLORANT | LATEX 2 | COLORANT | 95° C. | 10 | hrs | 5.4 | μm |
| PARTICLE Y2 | HML | DISPERSION 2 | | | | | |
| COLORANT | LATEX 1 | COLORANT | 85° C. | 10 | hrs | 5.5 | μm |
| PARTICLE Y3 | HML | DISPERSION 2 | | | | | |
| COLORANT | LATEX 1 | COLORANT | 85° C. | 6 | hrs | 5.5 | μm |
| PARTICLE Y4 | HML | DISPERSION 2 | | | | | |
| COLORANT | LATEX 1 | COLORANT | 99° C. | 10 | hrs | 5.5 | μm |
| PARTICLE Y5 | HML | DISPERSION 2 | | | | | |
| (COMPARATIVE) | | | | | | | |
| COLORANT | LATEX 1 | COLORANT | 85° C. | 6 | hrs | 5.6 | μm |
| PARTICLE Y6 | HM | DISPERSION 2 | | | | | |
| (COMPARATIVE) | | | | | | | |
| COLORANT | LATEX 1 | COLORANT | 95° C. | 10 | hrs | 5.5 | μm |
| PARTICLE M1 | HML | DISPERSION 3 | | | | | |
| COLORANT | LATEX 2 | COLORANT | 95° C. | 10 | hrs | 5.4 | μm |
| PARTICLE M2 | HML | DISPERSION 3 | | | | | |
| COLORANT | LATEX 1 | COLORANT | 85° C. | 10 | hrs | 5.5 | μm |
| PARTICLE M3 | HML | DISPERSION 3 | | | | | |
| COLORANT | LATEX 1 | COLORANT | 85° C. | 6 | hrs | 5.5 | μm |
| PARTICLE M4 | HML | DISPERSION 3 | | | | | |
| COLORANT | LATEX 1 | COLORANT | 99° C. | 10 | hrs | 5.5 | μm |
| PARTICLE M5 | HML | DISPERSION 3 | | | | | |
| (COMPARATIVE) | | | | | | | |
| COLORANT | LATEX 1 | COLORANT | 85° C. | 6 | hrs | 5.6 | μm |
| PARTICLE M6 | HM | DISPERSION 3 | | | | | |
| (COMPARATIVE) | | | | | | | |
| COLORANT | LATEX 1 | COLORANT | 95° C. | 10 | hrs | 5.5 | μm |
| PARTICLE C1 | HML | DISPERSION 4 | | | | | |
| COLORANT | LATEX 2 | COLORANT | 95° C. | 10 | hrs | 5.4 | μm |
| PARTICLE C2 | HML | DISPERSION 4 | | | | | |
| COLORANT | LATEX 1 | COLORANT | 85° C. | 10 | hrs | 5.5 | μm |
| PARTICLE C3 | HML | DISPERSION 4 | | | | | |
| COLORANT | LATEX 1 | COLORANT | 85° C. | 6 | hrs | 5.5 | μm |
| PARTICLE C4 | HML | DISPERSION 4 | | | | | |
| COLORANT | LATEX 1 | COLORANT | 99° C. | 10 | hrs | 5.5 | μm |
| PARTICLE C5 | HML | DISPERSION 4 | | | | | |
| (COMPARATIVE) | | | | | | | |
| COLORANT | LATEX 1 | COLORANT | 89° C. | 6 | hrs | 5.6 | μm |
| PARTICLE C6 | HM | DISPERSION 4 | | | | | |
| (COMPARATIVE) | | | | | | | |

[Production Example of Toner]

1.0 part by mass of hydrophobic silica (number average particle diameter of 12 nm), and 1.2 parts by mass of hydrophobic titanium oxide (number average particle diameter of 25 nm) were added to 100 parts by mass of each of the colorant particles K1 to the colorant particles C6, and the mixture was mixed using the Henschel mixer, to thereby obtain Toners K1 to K6, Y1 to Y6, M1 to M5, and C1 to C5.

Incidentally, the shape and particle diameter of toner particles forming these toners did not change by addition of external additives.

[Compressive Strength and Average Circularity of Toner]

The compressive strength and standard deviation thereof of each of the toners obtained were measured in the manner described below. Further, using the flow-type particle image analyzer “FPIA-2000” (available from To a Medical Electronics Co., Ltd.), the average circularity and standard deviation thereof were measured based on values of the shape factor of 500 toner particles. Results of the measurement are shown in Table 2.

[Measurement of Compressive Strength and Standard Deviation thereof]

Using micro compression testing machine (available from Shimadzu Corporation), under the measurement environment of a temperature of 21° C. and a relative humidity of 50% RH, and measurement conditions of a maximum test load of 9.8 mN and a load speed of 0.89 mN/sec, the micro compressive strength of each of ten toner particles having a number average particle diameter within a range of +20% was measured by a surface indentor, and an arithmetic average value of a total of 6 measurement values obtained by excluding two largest measurement values and two smallest measurement values from the results of the measurement was calculated as the compressive strength. Further, the standard deviation of compressive strength was also calculated.

TABLE 2

| | | | STANDARD | | |
|---|---|---|---|---|---|
| | | | DEVIA- | | STANDARD |
| | | | TION OF | | DEVIA- |
| | COLORANT | COMPRESS- | COMPRESS- | AVERAGE | TION OF |
| TONER | PARTICLE | IVE | IVE | CIRCU- | CIRCU- |
| NUMBER | NUMBER | STRENGTH | STRENGTH | LARITY | LARITY |
| TONER K1 | COLORANT | 14.3 | 0.70 | 0.976 | 0.026 |
| | PARTICLE K1 | | | | |
| TONER K2 | COLORANT | 14.7 | 0.72 | 0.976 | 0.029 |
| | PARTICLE K2 | | | | |
| TONER K3 | COLORANT | 16.3 | 0.70 | 0.973 | 0.023 |
| | PARTICLE K3 | | | | |
| TONER K4 | COLORANT | 17.7 | 0.72 | 0.967 | 0.023 |
| | PARTICLE K4 | | | | |
| TONER K5 | COLORANT | 12.2 | 1.20 | 0.993 | 0.010 |
| (COMPARATIVE) | PARTICLE K5 | | | | |
| | (COMPARATIVE) | | | | |
| TONER K6 | COLORANT | 21.1 | 1.20 | 0.952 | 0.049 |
| (COMPARATIVE) | PARTICLE K6 | | | | |
| | (COMPARATIVE) | | | | |
| TONER Y1 | COLORANT | 14.1 | 0.69 | 0.978 | 0.025 |
| | PARTICLE Y1 | | | | |
| TONER Y2 | COLORANT | 14.6 | 0.73 | 0.977 | 0.028 |
| | PARTICLE Y2 | | | | |
| TONER Y3 | COLORANT | 16.4 | 0.71 | 0.972 | 0.022 |
| | PARTICLE Y3 | | | | |
| TONER Y4 | COLORANT | 17.7 | 0.72 | 0.964 | 0.023 |
| | PARTICLE Y4 | | | | |
| TONER Y5 | COLORANT | 12.2 | 1.22 | 0.995 | 0.010 |
| (COMPARATIVE) | PARTICLE Y5 | | | | |
| | (COMPARATIVE) | | | | |
| TONER Y6 | COLORANT | 21.1 | 1.20 | 0.950 | 0.046 |
| (COMPARATIVE) | PARTICLE Y6 | | | | |
| | (COMPARATIVE) | | | | |
| TONER M1 | COLORANT | 14.3 | 0.73 | 0.977 | 0.025 |
| | PARTICLE M1 | | | | |
| TONER M2 | COLORANT | 14.7 | 0.71 | 0.976 | 0.028 |
| | PARTICLE M2 | | | | |
| TONER M3 | COLORANT | 16.3 | 0.73 | 0.974 | 0.023 |
| | PARTICLE M3 | | | | |
| TONER M4 | COLORANT | 17.7 | 0.72 | 0.962 | 0.023 |
| | PARTICLE M4 | | | | |
| TONER M5 | COLORANT | 12.2 | 1.19 | 0.994 | 0.012 |
| (COMPARATIVE) | PARTICLE M5 | | | | |
| | (COMPARATIVE) | | | | |
| TONER M6 | COLORANT | 21.1 | 1.20 | 0.951 | 0.042 |
| (COMPARATIVE) | PARTICLE M6 | | | | |
| | (COMPARATIVE) | | | | |
| TONER C1 | COLORANT | 14.4 | 0.70 | 0.978 | 0.022 |
| | PARTICLE C1 | | | | |
| TONER C2 | COLORANT | 14.6 | 0.72 | 0.972 | 0.023 |
| | PARTICLE C2 | | | | |
| TONER C3 | COLORANT | 16.3 | 0.70 | 0.971 | 0.020 |
| | PARTICLE C3 | | | | |
| TONER C4 | COLORANT | 17.5 | 0.72 | 0.960 | 0.020 |
| | PARTICLE C4 | | | | |
| TONER C5 | COLORANT | 12.3 | 1.21 | 0.996 | 0.010 |
| (COMPARATIVE) | PARTICLE C5 | | | | |
| | (COMPARATIVE) | | | | |
| TONER C6 | COLORANT | 21.4 | 1.22 | 0.948 | 0.047 |
| (COMPARATIVE) | PARTICLE C6 | | | | |
| | (COMPARATIVE) | | | | |

### Preparation Example 1 of Toner Carrier

An aluminum roller with an external diameter of 14 mm was prepared as a conductive substrate, set in an elastic layer forming mold, and an elastic layer coating liquid, referred to hereinafter, was injected around the periphery of the roller in the mold, and cured by heating at 120° C. for 5 minutes. Further, a composite was obtained by heating the aluminum roller and the elastic layer coating liquid with the mold removed therefrom at 150° C. for one hour, and a surface of the composite was polished by a traverse-type cylindrical grinder, whereby an elastic layer having a thickness of 1 mm was formed on the periphery of the aluminum roller.

After the elastic layer formed on the outer periphery of the aluminum roller was subjected to a surface treatment using a silane coupling agent, an intermediate layer coating liquid, referred to hereinafter, was sprayed onto the surface of the elastic layer to form a coating, and the coating was dried, whereby an intermediate layer with a thickness of 10 μm was formed on the surface of the elastic layer.

Further, a surface layer coating liquid, referred to hereafter, was sprayed onto a surface of the intermediate layer formed on the surface of the elastic layer on the periphery of the aluminum roller to form a coating, and the coating was dried, whereby a surface layer with a thickness of 18 μm was formed on the surface of the intermediate layer. Thus, a toner carrier (hereinafter also referred to as “the toner carrier (1)”) was formed which has the elastic layer having a thickness of 1 mm, the intermediate layer having a thickness of 10 μm, and the surface layer having a thickness of 18 μm, laminated on the conductive substrate, in the mentioned order.

[Preparation of Elastic Layer Coating Liquid]

50 parts by mass of liquid A and 50 parts by mass of liquid B of liquid silicone rubber “KE-1935” (available from Shin-Etsu Chemical Co., Ltd.), and 8 parts by mass of conductive carbon black “#3030” (available from Mitsubishi Chemical Co., Ltd.) were mixed and defoamed for 3 minutes by a stirring/defoaming apparatus “Hybrid Mixer H” (available from Keyence Corporation), whereby the elastic layer coating liquid was prepared.

[Preparation of Intermediate Layer Coating Liquid]

0.2 parts by mass of conductive carbon black “Ketjen black” (available from Lion Akzo Co., Ltd.) and 0.3 parts by mass of conductive carbon black “Printex XE2” (available from Degussa AG) were added to a solution prepared by dissolving 5 parts by mass of styrene butadiene elastomer “AR-S39948A” (available from Aron Kasei Co., Ltd) in 100 parts by mass of toluene as a solvent, and the obtained liquid mixture was uniformly dispersed by the stirring/defoaming apparatus “Hybrid Mixer H” (available from Keyence Corporation), whereby the intermediate layer coating liquid was prepared.

[Preparation of Surface Layer Coating Liquid]

100 parts by mass of polyurethane resin emulsion “YODOSOLRX-7” (available from Japan NSC Co., Ltd.) having a solid content of 35 wt %, 0.35 parts by mass of conductive carbon black “Valcan XC-7” (available from Cabot Corporation), 3.5 parts by mass of roughness-imparting particles “Silica Sylophere 470” (available from Fuji Silysia Chemical LTD), and 8 mass % of polymethyl methacrylate particles “Epostar MA-1010” (available from Nippon Shokubai Co., Ltd.) having an average particle diameter of 10 μm are mixed and defoamed for 3 minutes by the stirring/defoaming apparatus “Hybrid Mixer H” (available from Keyence Corporation), whereby a surface layer coating liquid was prepared.

The volume resistitivities of the layers constituting the toner carrier (1) obtained, and the arithmetic average roughness of the toner carrier were calculated by a method, referred to hereinafter, and the ten-point average roughness Rz of the toner carrier was also calculated. The results are shown in Table 3.

[Measurement of Volume Resistitivities of Layers]

In measuring the volume resistitivities of the elastic layer and the surface layer, a layer to be measured (elastic layer or surface layer) was formed according to the same method employed in preparing the toner carrier (1) on the surface of the aluminum roller in Preparation Example 1 of Toner Carrier, and 100 V of voltage was applied to the layer with a roller-shaped metal electrode pressed against the layer to be measured, whereby the volume resistitivity of the layer was measured.

Further, in measuring the volume resistitivity of the intermediate layer, a layer (intermediate layer) to be measured was formed according to the same method employed in producing the toner carrier (1) on the surface of the aluminum roller in Preparation Example 1 of Toner Carrier, and 100 V of voltage was applied to the layer with the roller-shaped metal electrode pressed against the layer, whereby the volume resistitivity of the intermediate layer was measured.

[Measurement of Arithmetic Average Roughness]

The arithmetic average roughness of the toner carrier (1) was measured using a surface roughness measure “Surfcom 1400A” (available from Tokyo Seimitsu company limited), under measuring conditions of a scanning speed of 0.3 mm/sec, cutoff of 0.8 mm, measuring length of 4 mm, and measuring pressure of 0.7 mm/N.

### Preparation Example 2 of Toner Carrier

A toner carrier (hereinafter also referred to as “the toner carrier (2)”) was prepared in the same manner as in Preparation Example 1 of Toner Carrier except that in preparing a surface layer coating liquid, 3.5 parts by mass of roughness-imparting particles “Silica Sylophere 380” (available from Fuji Silysia Chemical LTD) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 12 mass %.

The respective volume resistitivities of layers constituting the toner carrier (2) obtained, and the arithmetic average roughness of the same were calculated in the same manner as in Preparation Example 1 of Toner Carrier. Further, the ten-point average roughness Rz of the toner carrier was calculated. The results are shown in Table 3.

### Preparation Example 3 of Toner Carrier

A toner carrier (hereinafter also referred to as “the toner carrier (3)”) was prepared in the same manner as in Preparation Example 1 of Toner Carrier except that in preparing a surface layer coating liquid, 5.0 parts by mass of roughness-imparting particles “Methyl silicone MSP-150” (available from Nikko Fine Products, Ltd) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 14 mass %.

The respective volume resistitivities of layers constituting the toner carrier (3) obtained, and the arithmetic average roughness of the same were calculated in the same manner as in Preparation Example 1 of Toner Carrier. Further, the ten-point average roughness Rz of the toner carrier was calculated. The results are shown in Table 3.

### Preparation Example 4 of Toner Carrier

A toner carrier (hereinafter also referred to as “the toner carrier (4)”) was prepared in the same manner as in Preparation Example 1 of Toner Carrier except that in preparing a surface layer coating liquid, 4.0 parts by mass of roughness-imparting particles “Silica Sylophere #440” (available from Fuji Silysia Chemical LTD) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 4 mass %.

The respective volume resistitivities of layers constituting the toner carrier (4) obtained, and the arithmetic average roughness of the same were calculated in the same manner as in Preparation Example 1 of Toner Carrier. Further, the ten-point average roughness Rz of the toner carrier was calculated. The results are shown in Table 9.

### Preparation Example 5 of Toner Carrier

A toner carrier (hereinafter also referred to as “the toner carrier (5”) was prepared in the same manner as in Preparation Example 1 of Toner Carrier except that in preparing a surface layer coating liquid, 6 parts by mass of roughness-imparting particles “Acrylic Particle EAX-20 (available from Sekisui Plastic Co., Ltd.) were used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 am was changed to 12 mass %.

The respective volume resistitivities of layers constituting the toner carrier (5) obtained, and the arithmetic average roughness of the same were calculated in the same manner as in Preparation Example 1 of Toner Carrier. Further, the ten-point average roughness Rz of the toner carrier was calculated. The results are shown in Table 3.

TABLE 3

| | | | | ARISMETIC | |
|---|---|---|---|---|---|
| | | | | AVERAGE | |
| | VOLUME RESISTITIVITY (Ω • m) | | | ROUGHNESS | |
| | σ 1 | σ 2 | σ 3 | Ra (μm) | Rz |
| TONER | 4.8 × 10⁴ | 1.2 × 10³ | 2.7 × 10⁸ | 1.7 | 8.2 |
| CARRIER 1 | | | | | |
| TONER | 4.8 × 10⁴ | 1.2 × 10³ | 2.7 × 10⁸ | 1.0 | 12.3 |
| CARRIER 2 | | | | | |
| TONER | 4.8 × 10⁴ | 1.2 × 10³ | 2.7 × 10⁸ | 2.1 | 14.1 |
| CARRIER 3 | | | | | |
| TONER | 4.8 × 10⁴ | 1.2 × 10³ | 2.7 × 10⁸ | 0.7 | 4.2 |
| CARRIER 4 | | | | | |
| TONER | 4.8 × 10⁴ | 1.2 × 10³ | 2.7 × 10⁸ | 2.6 | 16.2 |
| CARRIER 5 | | | | | |

[Copying tests 1 to 12]

30,000 copies of a full color image print with a pixel ratio of 30% were continuously formed by using toners shown in Table 4 and Table 5 as non-magnetic single component developers, using an image forming apparatus constructed as shown in FIG. 1 and equipped with a developing device equipped with a toner carrier shown in Table 4 and Table 5, under normal temperature and normal humidity conditions of 20° C. and 50% RH. It was visually checked whether or not a 30,000-th image had image defects, and at the same time the absolute image density was measured by a Macbeth reflection densitometer “RD-918”, at arbitrary 20 points of white portions of the 30,000-th image, with no fixed character images printed thereon to calculate an average value of the absolute value density. Then, a difference between this average value and an average value of values of the absolute image density measured at arbitrary 20 points of a transfer paper not yet subjected to image forming processing was calculated as a fog density. The results of the calculations are shown in Table 10 and Table 11.

TABLE 4

| | | FOGGING | TONER | IMAGE |
|---|---|---|---|---|
| | DEVELOPER | DENSITY | CARRIER | DEFECT |
| COPYING | TONER K1 | 0.002 | TONER | NONE |
| TEST 1 | TONER Y1 | | CARRIER 1 | |
| | TONER M1 | | | |
| | TONER C1 | | | |
| COPYING | TONER K1 | 0.002 | TONER | NONE |
| TEST 2 | TONER Y1 | | CARRIER 2 | |
| | TONER M1 | | | |
| | TONER C1 | | | |
| COPYING | TONER K1 | 0.003 | TONER | NONE |
| TEST 3 | TONER Y1 | | CARRIER 3 | |
| | TONER M1 | | | |
| | TONER C1 | | | |
| COPYING | TONER K2 | 0.002 | TONER | NONE |
| TEST 4 | TONER Y2 | | CARRIER 1 | |
| | TONER M2 | | | |
| | TONER C2 | | | |
| COPYING | TONER K3 | 0.002 | TONER | NONE |
| TEST 5 | TONER Y3 | | CARRIER 1 | |
| | TONER M3 | | | |
| | TONER C3 | | | |
| COPYING | TONER K6 | 0.004 | TONER | NONE |
| TEST 6 | TONER Y6 | | CARRIER 1 | |
| | TONER M6 | | | |
| | TONER C6 | | | |

As results of the copying tests (1) to (6), it was confirmed that high-quality images can be stably obtained by the non-magnetic single component development system, since the developers used are formed of the predetermined toners, and the used toner carriers are the predetermined ones.

The toner according to the present invention is a toner obtained by carrying out the step of salting-out/fusing resin particles and colorant particles in a water-base medium. The toner has a specific compressive strength and a standard deviation thereof, and therefore it is possible to obtain an excellent image formability and high toughness. This makes it possible to give a necessary amount of electric charge to the toner without detrimental effects of the action of frictional charge by the toner carrier and the toner layer limiting member, and therefore, obtain a high-quality image over a long time period.

Therefore, according to the toner of the present invention, it is possible to stably obtain a high-quality image by the non-magnetic single component development system.

Further, the non-magnetic single component developing toner according to the invention has the above characteristics, and the predetermined number average particle diameter, average circularity, and standard deviation thereof. Therefore, it is possible to more stably obtain high-quality full-color images.

The image forming method of the present invention uses the toner described heretofore as the non-magnetic single component developer, and therefore it is possible to stably obtain high-quality images.

Further, in the image forming method according to the present invention, when a toner carrier has a predetermined construction, it is possible to obtain higher-quality images with higher stability.

The entire disclosure of Japanese Patent Application No. Tokugan 2002-273208 filed on Sep. 19, 2002 including specification, claims drawings and summary are incorporated herein by reference in its entirety.

What is claimed is:

1. A toner comprising a resin and a colorant, wherein the toner is obtained by carrying out a step of salting-out/fusing resin particles and colorant particles in a water-base medium, the toner having a compressive strength of 14 to 20, and a standard deviation of the compressive strength of smaller than 1.

2. The toner of claim 1, wherein the toner has a peak or a shoulder in a molecular weight distribution range from 100,000 to 1,000,000, and from 1,000 to 50,000.

3. The toner of claim 1, further comprising an external additive having an average primary particle diameter of 30 to 500 nm.

4. The toner of claim 1, wherein the resin particles of the toner have a softening point of 90 to 140° C.

5. A toner for a non-magnetic single component full-color development, which is used in an image forming method in which a yellow toner (Y), a magenta toner (M), a cyan toner (C), and a black toner (K) are used, the image forming method comprising the steps of: limiting an amount of each toner on a surface of a toner carrier by allowing a toner layer limiting member to be pressed to the surface of the toner carrier; and developing an electrostatic latent image formed on a surface of an electrostatic latent image carrier using the each toner carried and transferred by the toner carrier, based on a non-magnetic single component development system, wherein the toner is obtained by carrying out a step of salting-out/fusing resin particles and colorant particles in a water-base medium, and has a number average particle diameter of 3 to 9 μm, an average circularity of 0.955 to 0.990, a standard deviation of the average circularity of not larger than 0.040, a compressive strength of 14 to 20, and a standard deviation of the compressive strength of smaller than 1.

6. The toner of claim 5, wherein the toner has a peak or a shoulder in a molecular weight distribution range from 100,000 to 1,000,000, and from 1,000 to 50,000.

7. The toner of claim 5, further comprising an external additive having an average primary particle diameter of 30 to 500 nm.

8. The toner of claim 5, wherein the resin particles of the toner have a softening point of 90 to 140° C.

9. An image forming method comprising the steps of:
limiting an amount of toner on a surface of a toner carrier by allowing a toner layer limiting member to be pressed to the surface of the toner carrier; and
developing an electrostatic latent image formed on an electrostatic latent image carrier using the toner carried and transferred by the toner carrier, based on a non-magnetic single component development system, wherein the toner comprises a resin and a colorant, and is obtained by carrying out a step of salting-out/fusing resin particles and colorant particles in a water-base medium, the toner having a compressive strength of 14 to 20, and a standard deviation of the compressive strength of smaller than 1.

10. The image forming method of claim 9, wherein the toner has a peak or a shoulder in a molecular weight distribution range from 100,000 to 1,000,000, and from 1,000 to 50,000.

11. The image forming method of claim 9, wherein the toner further comprises an external additive having an average primary particle diameter of 30 to 500 nm.

12. The image forming method of claim 9, wherein the resin particles of the toner have a softening point of 90 to 140° C.

13. An image forming method comprising the steps of:
limiting an amount of toner on a surface of a toner carrier by allowing a toner layer limiting member to be pressed to the surface of the toner carrier; and
developing an electrostatic latent image formed on an electrostatic latent image carrier using the toner carried and transferred by the toner carrier, based on a non-magnetic single component development system, wherein the toner is obtained by carrying out a step of salting-out/fusing resin particles and colorant particles in a water-base medium, and has a number average particle diameter of 3 to 9 mm, an average circularity of 0.955 to 0.990, a standard deviation of the average circularity of not larger than 0.040, a compressive strength of 14 to 20, and a standard deviation of the compressive strength of smaller than 1, and wherein the toner carrier has an arithmetic average roughness Ra of 0.8 to 2.5 μm and a ten-point average roughness Rz of 5.0 to 15.0.

14. The image forming method of claim 13, wherein the toner has a peak or a shoulder in a molecular weight distribution range from 100,000 to 1,000,000, and from 1,000 to 50,000.

15. The image forming method of claim 13, wherein the toner further comprises an external additive having an average primary particle diameter of 30 to 500 nm.

16. The image forming method of claim 13, wherein the resin particles of the toner have a softening point of 90 to 140° C.
